(19) United States
(12) Patent Application Publication
(10) Pub. No.: US 2017/0212378 A1
(43) Pub. Date: Jul. 27, 2017

(54) LIQUID CRYSTAL APPARATUS AND ELECTRONIC EQUIPMENT

(71) Applicant: Seiko Epson Corporation, Tokyo (JP)

(72) Inventors: Akihide Haruyama, Suwa-shi (JP); Yoshitake Tateno, Chitose-shi (JP)

(21) Appl. No.: 15/405,295

(22) Filed: Jan. 12, 2017

(30) Foreign Application Priority Data
Jan. 22, 2016 (JP) 2016-010538
Oct. 21, 2016 (JP) 2016-206617

(51) Int. Cl. G02F 1/13363; G02F 1/1335; G02F 1/1368

(52) U.S. Cl. CPC G02F 1/13363; G02F 1/1368; G02F 1/133526

(57) ABSTRACT

A liquid crystal panel has an element substrate which emits light transmitted through a microlens, a liquid crystal which transmits light incident from the element substrate, a counter substrate which transmits light emitted from the liquid crystal, and an optical compensation plate provided on a light emission side of the element substrate.

### BACKGROUND

1. Technical Field

The present invention relates to an electro-optical apparatus and electronic equipment which incorporates the electro-optical apparatus; and particularly relates to an electro-optical apparatus provided with a microlens array and electronic equipment which uses the same.

2. Related Art

For example, a liquid crystal apparatus used as a light valve of a projector which enlarges and projects an image is known. In such a liquid crystal apparatus, in order to realize a bright display by effectively utilizing the light emitted from the light source, a configuration has been proposed which is provided with a microlens for condensing incident light for each pixel in the substrate on the light incidence side. In addition, there is also known a technique for improving the contrast reduction caused by the decrease in aperture ratio due to the wiring on the substrate.

For example, JP-A-2011-164373 discloses a liquid crystal apparatus having an optical compensation plate which is tiltable and rotatable with respect to the optical axis of a liquid crystal cell.

In addition, for example, JP-A-2003-140127 discloses a technique of providing microlenses on the element substrate side in a liquid crystal display apparatus into which light is incident from the counter substrate side.

In addition, JP-A-2013-178556 discloses a technique of compensating for the influence of diffraction by the microlens by using two phase difference plates in a liquid crystal display apparatus into which light is incident from the counter substrate side.

In addition, for example, Japanese Patent No. 3071045 discloses a liquid crystal display apparatus in which a first microlens array for converging incident light to a liquid crystal pixel portion is arranged on the light incident surface side of a liquid crystal display panel, a second microlens array which converts the light transmitted through the liquid crystal pixel portion into parallel light is arranged on the light emission surface side of the liquid crystal display panel, the light emission surface described above is a convex curved surface, and light emitted from the second microlens is converged toward a projection lens unit. According to the liquid crystal display apparatus of Japanese Patent No. 3071045, even if the aperture of the projection lens unit is small, most of the light from the liquid crystal display panel passes through the projection lens unit, that is, the utilization efficiency of light is improved.

In addition, for example, JP-A-2009-63888 discloses a liquid crystal display apparatus which is provided with a first substrate including first optical elements into which incident light is incident corresponding to each of a plurality of pixels, a second substrate including second optical elements into which incident light incident through the first optical element is emitted corresponding to each of a plurality of pixels, and a liquid crystal layer interposed between the first substrate and the second substrate. In JP-A-2009-63888, a microlens is given as an example of the first optical element and a micro prism is given as an example of the second optical element. Accordingly, since it is possible for the incident light condensed by the microlens provided on the first substrate to be converted to the direction along the optical axis of the incident light by the micro prisms provided on the second substrate, the utilization efficiency of the incident light is improved. In addition, it is possible to miniaturize the liquid crystal display apparatus in comparison with a case of providing a first microlens which condenses incident light on the first substrate side and a second microlens which converts the light condensed by the first microlens into parallel light.

In JP-A-2011-164373, there is a problem in that the light utilization efficiency is not sufficient.

In JP-A-2003-140127 and JP-A-2013-178556, there is a problem in that the light emitted from the liquid crystal layer is diffracted by the element or the like of the element substrate, the effect of light condensation by the microlens is weakened, the light utilization efficiency decreases, and the contrast decreases.

In Japanese Patent No. 3071045 and JP-A-2009-63888, there is a concern that the contrast in the display may decrease. Specifically, the light emitted from the liquid crystal display apparatus includes light transmitted through the liquid crystal layer of the liquid crystal pixel portion (pixel) along the optical axis and light transmitted obliquely with respect to the optical axis. The liquid crystal layer is formed of liquid crystal molecules aligned in a predetermined direction. Since the liquid crystal layer has refractive index anisotropy (birefringence) attributable to liquid crystal molecules and the alignment thereof, a phase difference occurs between the light transmitted through the liquid crystal layer along the optical axis and the light transmitted obliquely with respect to the optical axis. Furthermore, when the condensing capability of the microlens is increased in order to effectively utilize the incident light, there is a problem in that the light transmitted obliquely with respect to the optical axis is increased more than the light transmitted along the optical axis, and the phase difference becomes remarkable. Therefore, due to this phase difference, there is a concern that light leakage will occur, for example, when black display is performed, and the contrast will be lowered.

In addition, in JP-A-2009-63888 described above, on the second substrate, a black matrix layer (light-shielding layer) provided in a grid pattern so as to partition pixel electrodes and a pixel switching element provided on a lower layer of the black matrix layer are provided. Accordingly, in order to effectively utilize the incident light, it is necessary to efficiently guide the light condensed by the microlens of the first substrate to the region partitioned by the black matrix layer of the second substrate. That is, there is a problem of how to further improve the utilization efficiency of the incident light while suppressing the decrease in contrast.

### SUMMARY

The invention can be realized in the following aspects or application examples.

### APPLICATION EXAMPLE

An electro-optical apparatus according to this application example includes an element substrate which emits light transmitted through a microlens, an electro-optical layer which transmits light incident from the element substrate, a counter substrate which transmits light incident from the electro-optical layer, and an optical compensation plate provided on a light emission side of the element substrate.

According to this electro-optical apparatus, it is possible to condense the incident light by the microlens and efficiently make the light incident to the electro-optical layer from the element substrate, and, it is possible for the light in which the diffracted light from the electro-optical layer is suppressed to effectively cancel (compensate for) the phase difference (equal refraction restoration effect) and the like generated in the electro-optical layer and the like using the optical compensation plate. For example, it is possible to efficiently emit light from a light source which is incident light, and furthermore, it is possible to emit light emitted from the electro-optical layer so as not to cause leakage of light at an emission side light-polarizing plate. Accordingly, it is possible to improve the brightness (light utilization effect) of the electro-optical apparatus and to improve the contrast.

In the electro-optical apparatus according to the application example described above, the optical compensation plate may be provided on a light emission side of the counter substrate.

According to this electro-optical apparatus, it is possible to easily form the optical compensation plate in the electro-optical apparatus. For example, it is possible to form the optical compensation plate by forming an organic film or an inorganic film on the counter substrate. In addition, it is possible to form the optical compensation plate by pasting a separate optical compensation plate (glass or a film) formed of an organic film or an inorganic film on the counter substrate using an adhesive.

In the electro-optical apparatus according to the application example described above, the optical compensation plate may be provided on a light emission side of the electro-optical layer and on a light incident side of the counter substrate.

According to this electro-optical apparatus, the light emitted from the electro-optical layer is incident to the optical compensation plate before the counter substrate, the diffracted light is further suppressed, and it is possible to compensate for the phase difference generated in the electro-optical layer more effectively.

The electro-optical apparatus according to the application example described above may have a pixel electrode provided on the electro-optical layer side of the element substrate, and the optical compensation plate may be provided on the element substrate side of the pixel electrode.

According to this electro-optical apparatus, light is incident to the optical compensation plate and is emitted from the electro-optical layer, the diffracted light is further suppressed, and it is possible to compensate for the phase difference generated in the electro-optical layer more effectively.

The optical compensation plate may be formed of an inorganic material.

According to this electro-optical apparatus, it is possible to form an electro-optical apparatus in which the light resistance and heat resistance of the optical compensation plate are improved.

In the electro-optical apparatus according to the application example described above, the optical compensation plate may include a uniaxial phase difference plate.

According to this electro-optical apparatus, it is possible to uniaxially compensate for the phase difference.

In the electro-optical apparatus according to the application example described above, the optical compensation plate may include a C plate.

According to this electro-optical apparatus, it is possible to compensate for the phase difference.

In the electro-optical apparatus according to the present application example, the optical compensation plate may include a biaxial phase difference plate.

According to this electro-optical apparatus, it is possible to biaxially compensate for the phase difference.

Electronic equipment according to an aspect of the invention includes the electro-optical apparatus according to the invention described above.

According to this electronic equipment, it is possible to improve the brightness and contrast.

### APPLICATION EXAMPLE

A liquid crystal apparatus according to this application example includes a liquid crystal layer which is interposed between a first substrate and a second substrate, in which light is incident from the first substrate side toward the liquid crystal layer, the first substrate has, for each pixel, a pixel electrode, a transistor related to switching control of the pixel electrode, a first microlens provided further to a light incident side than a wiring layer in which the transistor is provided, and a second microlens provided between the wiring layer and the liquid crystal layer, and is provided with an optical compensation plate which compensates for a phase difference of the liquid crystal layer.

According to the application example, since the first microlens and the second microlens are provided on the side of the first substrate to which the light is incident, it is possible to precisely arrange the position of the second microlens with respect to the first microlens on the optical axis and to suppress the decrease in the light utilization rate accompanying the positional shift between the two microlenses. In other words, it is possible to realize a high light utilization rate.

In addition, since the first microlens is arranged further to the light incident side than the wiring layer and the second microlens is arranged between the wiring layer and the liquid crystal layer, it is possible for light to be efficiently incident to the liquid crystal layer. For example, light incident to the first microlens with an angle of +θ (or −θ) with respect to the optical axis is refracted to an angle of +θ+α (or −θ−α) depending on the angle with respect to the normal line orthogonal to a plane (boundary surface) in contact with the point of incidence of light in the first microlens. Thus, the amount of light which is incident to the wiring layer and lost is reduced. In addition, it is possible to convert the light refracted by the first microlens to the angle of +θ+α (or −θ−α) into light having an original angle of approximately +θ (or −θ) with respect to the optical axis using the second microlens.

Accordingly, compared to a case without the second microlens, it is possible to reduce the angle of light obliquely transmitted through the liquid crystal layer with respect to the optical axis. In addition, since the phase difference due to the light obliquely transmitted through the liquid crystal layer is compensated for by the optical compensation plate, it is possible to provide a liquid crystal apparatus in which a decrease in the contrast due to the phase difference described above is suppressed as compared with a case where the optical compensation plate is not provided, and which has an excellent display quality while improving the utilization efficiency of light.

### APPLICATION EXAMPLE

Another liquid crystal apparatus according to this application example includes a liquid crystal layer which is interposed between a first substrate and a second substrate, in which light is incident from the first substrate side toward the liquid crystal layer, the first substrate has, for each pixel, a pixel electrode, a transistor related to switching control of the pixel electrode, and a first microlens provided further to a light incident side than a wiring layer in which the transistor is provided, the second substrate has, for each pixel, a second microlens provided corresponding to the first microlens, and is provided with an optical compensation plate which compensates for a phase difference of the liquid crystal layer.

According to the application example, since the first microlens is arranged further to the light incident side than the wiring layer and the second microlens is arranged on the second substrate in the first substrate, it is possible to provide a configuration capable of improving luminance unevenness caused by condensation or divergence of the light due to the microlenses.

In addition, since the phase difference caused by the light condensed by the first microlens being obliquely transmitted through the liquid crystal layer is compensated for by the optical compensation plate, a decrease in the contrast caused by the phase difference described above is suppressed in comparison with a case where the optical compensation plate is not provided. That is, it is possible to provide a liquid crystal apparatus having an excellent display quality while improving the utilization efficiency of incident light.

In the liquid crystal apparatus according to the application example described above, it is preferable that the optical compensation plate be provided on the light emission side of the second substrate.

According to this configuration, regardless of the configuration of the first substrate and the second substrate, it is possible to adopt various forms as the optical compensation plate. For example, it is possible to adopt a film obtained by uniaxial stretching or biaxial stretching or a refractive anisotropic body formed using an inorganic material as an optical compensation plate. Alternatively, the above may be combined to form an optical compensation plate.

The liquid crystal apparatus according to the application example described above may have a third substrate provided with the optical compensation plate and the third substrate may be provided on the light emission side of the second substrate.

With this configuration, using the liquid crystal apparatus as, for example, a light valve makes it possible to improve the decrease in contrast due to the phase difference described above while having the third substrate function as a dust-proof substrate.

In the liquid crystal apparatus according to the application example described above, it is preferable that the optical compensation plate be provided on the liquid crystal layer side of the second substrate.

According to this configuration, incorporating the optical compensation plate in the second substrate makes it possible to compensate for the phase difference of the light immediately after being transmitted through the liquid crystal layer, and to realize a small liquid crystal apparatus.

In the liquid crystal apparatus according to the application example described above, the optical compensation plate may be provided on the liquid crystal layer side of the first substrate.

According to this configuration, even if the optical compensation plate is arranged on the light incident side of the liquid crystal layer, it is possible to compensate for the phase difference of the light after being transmitted through the liquid crystal layer, and to realize a small liquid crystal apparatus.

In the liquid crystal apparatus according to the application example described above, the optical compensation plate is at least one type selected from an A plate, a C plate, and an O plate.

According to this configuration, it is possible to properly compensate for the phase difference by selecting at least one type from the A plate, the C plate, and the O plate according to the birefringence in the liquid crystal layer.

In the liquid crystal apparatus described in the application example, it is preferable that the slow axis of the optical compensation plate be inclined in a direction opposite to the pretilt direction of the liquid crystal molecules in the liquid crystal layer.

According to this configuration, in addition to the phase difference caused by the light obliquely transmitted through the liquid crystal layer, the phase difference related to the pretilt of the liquid crystal molecules is able to be compensated.

### APPLICATION EXAMPLE

Electronic equipment according to this application example is provided with the liquid crystal apparatus according to the application example described above.

According to the application example, the utilization efficiency of the incident light and the decrease in the contrast due to the phase difference of light transmitted through the liquid crystal layer are improved, and it is possible to provide electronic equipment having excellent display quality.

### BRIEF DESCRIPTION OF THE DRAWINGS

The invention will be described with reference to the accompanying drawings, wherein like numbers reference like elements.

FIG. 1 is a diagram illustrating a configuration of a projector according to a first embodiment.

FIG. 2 is a diagram illustrating an electrical configuration of a liquid crystal panel according to one embodiment.

FIG. 3 is a diagram showing an equivalent circuit of a pixel.

FIG. 4 is a diagram illustrating an outline of a cross-sectional structure of a liquid crystal panel according to the first embodiment.

FIGS. 5A and 5B are diagrams comparing an optical path in the liquid crystal panel with a comparative example.

FIG. 6 is a diagram illustrating a structure of a liquid crystal panel according to Modification Example 1.

FIG. 7 is a diagram illustrating a structure of a liquid crystal panel according to Modification Example 2.

FIG. 8 is a diagram illustrating a structure of a liquid crystal panel according to Modification Example 3.

FIG. 9 is a schematic planar diagram showing a configuration of a liquid crystal apparatus according to a second embodiment.

FIG. 10 is a schematic cross-sectional diagram showing a structure of the liquid crystal apparatus taken along line X-X in FIG. 9.

FIG. 11 is a circuit diagram showing an electrical configuration of the liquid crystal apparatus according to the second embodiment.

FIG. 12 is a schematic planar diagram showing the arrangement of pixels in the liquid crystal apparatus of the second embodiment.

FIG. 13 is a schematic cross-sectional diagram showing the structure of a pixel in the liquid crystal apparatus of the second embodiment.

FIG. 14 is a schematic planar diagram showing an arrangement of microlenses in a pixel.

FIG. 15 is a diagram showing an example of a C plate (refractive index ellipsoid) as an optical compensation plate.

FIG. 16 is a diagram showing an example of an O plate (refractive index ellipsoid) as an optical compensation plate.

FIG. 17 is a schematic cross-sectional diagram showing a structure of a pixel in a liquid crystal apparatus according to a third embodiment.

FIG. 18 is a schematic cross-sectional diagram showing a structure of a pixel in a liquid crystal apparatus of a fourth embodiment.

FIG. 19 is a schematic cross-sectional diagram showing a structure of a pixel in a liquid crystal apparatus of a fifth embodiment.

FIG. 20 is a schematic cross-sectional diagram showing a structure of a pixel in a liquid crystal apparatus of a sixth embodiment.

FIG. 21 is a schematic cross-sectional diagram showing a structure of a pixel in a liquid crystal apparatus of a seventh embodiment.

FIG. 22 is a schematic cross-sectional diagram showing a structure of a pixel in a liquid crystal apparatus of an eighth embodiment.

FIG. 23 is a schematic diagram showing a configuration of a projection-type display apparatus as an example of electronic equipment according to a ninth embodiment.

FIG. 24 is a diagram showing an example of an A plate (refractive index ellipsoid) as an optical compensation plate.

### DESCRIPTION OF EXEMPLARY EMBODIMENTS

Below, embodiments embodying the invention will be described with reference to the drawings. Here, the drawings which are used are appropriately enlarged or reduced so as to display the illustrated parts in a recognizable manner.

### First Embodiment

### 1. CONFIGURATION

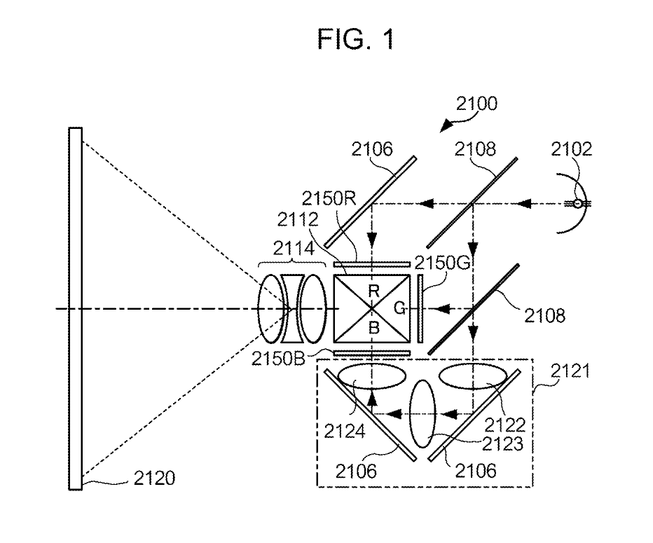

FIG. 1 is a diagram illustrating the configuration of the projector 2100 according to the first embodiment. The projector 2100 is an example of electronic equipment which is a display apparatus which projects a video corresponding to a video signal onto a screen 2120. In the projector 2100, the projection light is separated into a plurality of color components (in this example, three primary colors), and is modulated by an individual light valve (optical modulator) for each color component. The projector 2100 includes a lamp unit 2102, mirrors 2106, dichroic mirrors 2108, a light valve 2150R, a light valve 2150G, a light valve 2150B, a dichroic prism 2112, a projection lens group 2114, and a relay lens system 2121.

The lamp unit 2102 irradiates projection light. The projected light is separated into three primary colors of R (red), G (green), and B (blue) by the three mirrors 2106 and the two dichroic mirrors 2108. The separated projection light is guided to the light valves 2150R, 2150G, and 2150B corresponding to the respective primary colors. Here, since the light of the B color has a longer optical path as compared with the other R color or G color, the light of the B color is guided to the light valve 2150B via the relay lens system 2121 in order to prevent loss thereof. The relay lens system 2121 includes an incident lens 2122, a relay lens 2123, and an emission lens 2124.

The light valves 2150R, 2150G, and 2150B are driven according to the video signals for each color component. The light modulated by the light valves 2150R, 2150G, and 2150B is respectively incident to the dichroic prism 2112 from three directions. Then, in the dichroic prism 2112, the R color and B color lights are refracted by 90°, and the G color light goes straight ahead. Accordingly, after the images of the respective primary colors are synthesized, a color image is projected on the screen 2120 by the projection lens group 2114.

Here, since the light corresponding to each of the R, G, and B colors is incident to the light valves 2150R, 2150G, and 2150B by the dichroic mirrors 2108, it is not necessary to provide a color filter. In addition, the transmission images of the light valves 2150R and 2150B are projected after being reflected by the dichroic prism 2112, whereas the transmission image of the light valve 2150G is projected as it is. Accordingly, the horizontal scanning direction according to the light valves 2150R and 2150B is a direction opposite to the horizontal scanning direction according to the light valve 2150G, and an image in which the left and right are reversed is displayed in this configuration.

Below, each of the light valves 2150R, 2150G, and 2150B is simply referred to as a light valve 2150 unless a distinction is made. The light valve 2150 includes a liquid crystal panel which is an example of an electro-optical apparatus.

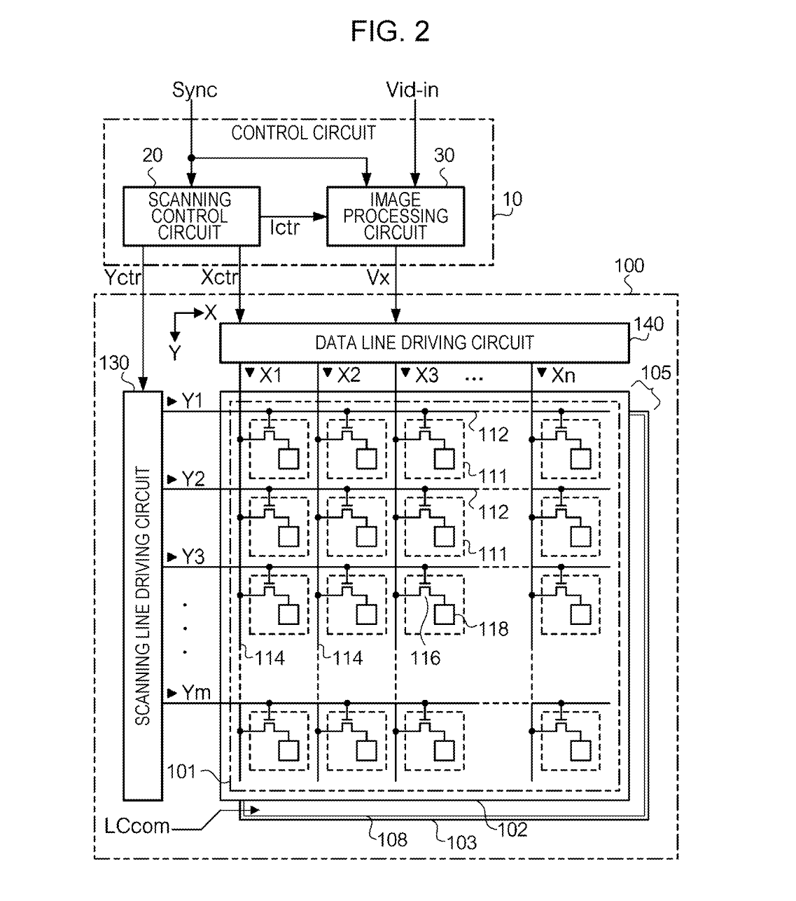

FIG. 2 is a diagram illustrating an electrical configuration of the liquid crystal panel 100 according to the first embodiment. The liquid crystal panel 100 is an apparatus for displaying an image in accordance with a signal supplied from the control circuit 10. The control circuit 10 includes a scanning control circuit 20 and a video processing circuit 30. The liquid crystal panel 100 includes a display region 101, a scanning line driving circuit 130, and a data line driving circuit 140. The display region 101 has pixels 111 arranged in a matrix in m rows and n columns. The scanning control circuit 20 generates a control signal Yctr and a control signal Xctr in accordance with a synchronization signal Sync. The control signal Yctr is a signal for controlling the scanning line driving circuit 130. The control signal Xctr is a signal for controlling the data line driving circuit 140. The video processing circuit 30 generates a data signal Vx in accordance with the synchronization signal Sync and an input video signal Vid-in. The data signal Vx is a signal indicating a voltage applied to each pixel 111.

The pixel 111 indicates an optical state corresponding to signals supplied from the scanning line driving circuit 130 and the data line driving circuit 140. The liquid crystal panel 100 displays an image by controlling the optical state of the plurality of pixels 111 in the display region 101.

The liquid crystal panel 100 includes an element substrate 102, a counter substrate 103, and a liquid crystal 105. The element substrate 102 and the counter substrate 103 each have a light-transmitting substrate such as glass or quartz. The element substrate 102 and the counter substrate 103 are attached to each other while maintaining a certain gap therebetween. The liquid crystal 105 is interposed in this gap. The liquid crystal 105 is an example of an electro-optical layer in which the optical state changes according to an applied voltage, and is, for example, a Vertical Alignment (VA) type liquid crystal having negative dielectric anisotropy.

The element substrate 102 is a substrate on which switching elements are formed among two substrates interposing the liquid crystal 105. The element substrate 102 has m scanning lines 112 and n data lines 114 on a surface facing the counter substrate 103. The scanning lines 112 are provided along the first direction (horizontal direction in the drawing) and the data lines 114 are provided along the second direction (vertical direction in the drawing), and are insulated from each other. Here, the direction in which the scanning lines 112 extend is referred to as the X direction, and the direction in which the data lines 114 extend is referred to as the Y direction. When one scanning line 112 is distinguished from the other scanning lines 112, the scanning lines 112 of the first, second, third, . . . , (m-1)th and mth rows are sequentially numbered from the top in the diagram. Similarly, when distinguishing one data line 114 from the other data lines 114, the data lines 114 are sequentially numbered from the left in the diagram as the first, second, third, . . . , (n-1) and nth data lines 114. The pixel 111 is provided corresponding to the intersection of the scanning lines 112 and the data lines 114 as viewed from a viewpoint at a position orthogonal to the X axis and the Y axis. Each of the plurality of pixels 111 has a pixel electrode 118.

The counter substrate 103 is a substrate different from the element substrate 102 among the two substrates interposing the liquid crystal 105. On the counter substrate 103, a common electrode 108 is provided. The common electrode 108 is an electrode for applying a voltage to the liquid crystal 105 and is common to the plurality of pixels 111. A voltage corresponding to the potential difference between the pixel electrode 118 and the common electrode 108 is applied to the liquid crystal 105. Hardly any structures causing diffraction of light are formed in the display region of the counter substrate 103, and diffraction of light does not occur as compared with the element substrate 102.

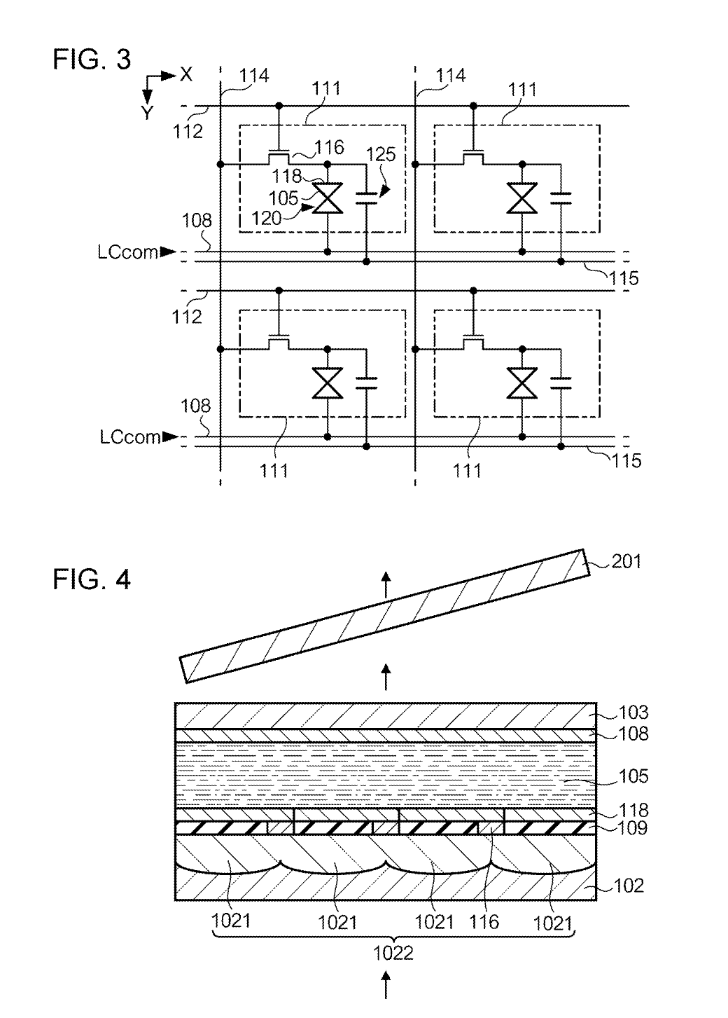

FIG. 3 is a diagram showing an equivalent circuit of the pixel 111. The pixel 111 includes a Thin Film Transistor (TFT) 116, a liquid crystal element 120, and a storage capacitor 125. The liquid crystal element 120 includes a pixel electrode 118, a liquid crystal 105, and a common electrode 108. The pixel electrode 118 is an electrode individually provided for each pixel 111. The common electrode 108 is an electrode common to all the pixels 111. The pixel electrode 118 is provided on the element substrate 102, and the common electrode 108 is provided on the counter substrate 103. The liquid crystal 105 is interposed between the pixel electrode 118 and the common electrode 108. The common voltage LCcom is applied to the common electrode 108. At least the TFT 116 among the elements illustrated in FIG. 3 is formed on the element substrate 102.

The TFT 116 is an example of a switching element for controlling the application of a voltage to the pixel electrode 118, and is an n-channel field effect transistor in this example. The TFTs 116 are individually provided for each pixel 111. The gates of the TFTs 116 of the i-th row and the j-th column are connected to the scanning line 112 of the i-th row, the source is connected to the data line 114 of the j-th column, and the drain is connected to the pixel electrode 118. One end of the storage capacitor 125 is connected to the pixel electrode 118, and the other end thereof is connected to the capacitor line 115. A voltage which is constant over time is applied to the capacitor line 115.

When a signal of a voltage of High (H) level (referred to below as “selection voltage”) is supplied to the scanning line 112 of the i-th row, the TFT 116 of the i-th row and the j-th column is turned on, and the source and the drain are conductive. At this time, when a signal of a voltage (referred to below as “data voltage”) corresponding to the gradation value (data) of the pixel 111 of the i-th row and j-th column is supplied to the data line 114 of the j-th column, the data voltage is applied to the pixel electrode 118 of the i-th row and the j-th column through the TFT 116.

After that, when a voltage of Low (L) level (referred to below as a “nonselective voltage”) is applied to the scanning line 112 of the i-th row, the TFT 116 is turned off and the source and the drain enter a high impedance state. The voltage applied to the pixel electrode 118 when the TFT 116 is on is held by the capacitive property of the liquid crystal element 120 and the storage capacitor 125 even after the TFT 116 is turned off.

A voltage corresponding to the potential difference between the data voltage and the common voltage is applied to the liquid crystal element 120. The molecular alignment state of the liquid crystal 105 changes in accordance with the voltage applied to the liquid crystal element 120. The optical state of the pixel 111 varies according to the molecular alignment state of the liquid crystal 105. For example, when the liquid crystal panel 100 is a transmissive panel, the optical state which is changed is the transmittance.

Reference will be made again to FIG. 2. The scanning line driving circuit 130 is a circuit which sequentially and exclusively selects one scanning line 112 from m scanning lines 112 (that is, which scans the scanning lines 112). Specifically, the scanning line driving circuit 130 supplies the scanning signal Yi to the i-th row scanning line 112 in accordance with the control signal Yctr. In this example, the scanning signal Yi is a selection voltage for the selected scanning line 112 and a non-selection voltage for the non-selected scanning line 112.

The data line driving circuit 140 is a circuit which outputs a signal indicating a data voltage (referred to below as “data signal”) to the n data lines 114. Specifically, the data line driving circuit 140 samples the data signal Vx supplied from the video processing circuit 30 in accordance with the control signal Xctr, and outputs the sampled data signal as data signals X1 to Xn to the data lines 114 of the first to nth columns. Here, in this explanation, for voltage other than the voltage applied to the liquid crystal element 120, the ground potential not shown is expressed as a reference (zero V) unless otherwise specified.

FIG. 4 is a diagram schematically illustrating an outline of the cross-sectional structure of the liquid crystal panel 100 according to the first embodiment. The liquid crystal panel 100 has an optical compensation plate 201 in addition to the element substrate 102, the liquid crystal 105, and the counter substrate 103. In this example, light from the light source is incident from the element substrate 102 side and is emitted via the element substrate 102, the liquid crystal 105, the counter substrate 103, and the optical compensation plate 201. Further, the liquid crystal panel 100 includes a pair of deflecting plates (not shown) on the light incident side (light source side) and the light emission side.

On the element substrate 102, on the light path, a microlens array 1022 is provided on the switching element, that is, upstream (the light incident side) of the TFT 116. The microlens array 1022 has a plurality of microlenses 1021. The microlenses 1021 are lenses for condensing incident light on the pixel electrode 118, and are provided for each pixel 111.

The shape of the microlens array 1022 is formed by, for example, patterning and etching using a photolithography technique. That is, first, a resist having a pattern corresponding to the microlens array 1022 is formed on the surface of the element substrate 102 main body, and recesses are formed by etching. After the resist is removed, the lens material is embedded in this recess, and the microlens array 1022 is formed. As the lens material, a material having a refractive index higher than that of the element substrate 102 main body is used. For example, in a case where quartz is used as the main body of the element substrate 102, an inorganic material such as SiON or Al₂O₃ is used as the lens material. The layer of the embedded lens material is planarized by a Chemical Mechanical Polishing (CMP) treatment, for example. The lens material of which the surface is flattened functions as a microlens array 1022. In this manner, the element substrate 102 including the microlens array 1022 is formed. As long as the microlens array 1022 is able to converge light on the pixel electrodes 118, the shape and the material thereof are not limited. In addition, the microlens array 1022 and the element substrate 102 may be formed as separate bodies and bonded together.

On the surface on the liquid crystal 105 side of the element substrate 102, a TFT 116, a scanning line 112, and a data line 114 are formed. Here, the scanning lines 112 and the data lines 114 are not shown in FIG. 4, and only the TFT 161 is shown as a representative of a structure formed on the surface of the liquid crystal 105 side. The main factor behind the diffraction of light in the element substrate 102 is the structure of the TFT 161. A pixel electrode 118 is formed further above the TFT 161 (downstream in the light path). The pixel electrode 118 is formed by patterning a light-transmitting conductive layer such as Indium Tin Oxide (ITO). In FIG. 4, the pixel electrode 118 is illustrated as a series of layers in order to simplify the drawing; however, in practice, the pixel electrodes 118 are separated for each pixel. In order to adjust the optical path, an interlayer film 109 is formed between the microlens array 1022 and the pixel electrode 118. The interlayer film 109 is formed of a material having an insulating property and a light-transmitting property, such as SiO₂, for example.

On the surface of the counter substrate 103 on the side of the liquid crystal 105, a common electrode 108 is formed.

The common electrode 108 is formed of a light-transmitting conductive layer such as ITO. The element substrate 102 and the counter substrate 103 are bonded to each other such that the electrode formation surfaces thereof are opposed to each other while maintaining a certain gap using a sealing material (not shown) including a spacer. The liquid crystal 105 is sealed in this gap. Alignment films (not shown) are formed on the sides of the element substrate 102 and the counter substrate 103 facing the liquid crystal 105, respectively. The alignment films are rubbed in a predetermined direction in order to align in the direction in which the liquid crystal molecules tilt at the time of voltage application. The predetermined direction is, for example, the direction from the upper right to the lower left with respect to the arrangement of the pixels 111 in the element substrate 102, and the direction from the lower left to the upper right in the counter substrate 103. Due to the alignment films, the VA type liquid crystal molecules are aligned in a direction inclined, for example, by 2 to 6° from a state orthogonal to the surfaces of the element substrate 102 and the counter substrate 103 when no voltage is applied. The liquid crystal molecules being tilted with respect to the substrate surface in a state where no voltage is applied is called pretilt, and the tilt at this time is referred to as the pretilt angle. The pretilt angle is, for example, 88 to 84°. Further, the alignment film may be an inorganic alignment film made of SiO₂ or the like, and the inorganic alignment film is formed by oblique vapor deposition from a predetermined direction, and a pretilt is imparted thereto.

On the downstream side (light emission side) of the counter substrate 103 in the light path, an optical compensation plate 201 is provided. The optical compensation plate 201 is an optical component for compensating for the phase difference of the light transmitted through the liquid crystal 105, and is, for example, a so-called C plate. A C plate refers to an optical component in which the refractive index (nx, xy) in the in-plane direction is different from the refractive index (nz) in the thickness direction, and in particular, a component where nx=ny>nz is called a negative C plate. The optical compensation plate 201 is used, for example, to compensate for the phase difference caused by the pretilt of the liquid crystal 105. In order to compensate for the phase difference due to the pretilt, the optical compensation plate 201 is arranged to be inclined with respect to the substrate surface of the counter substrate 103. The optical compensation plate 201 may have an angle adjustment mechanism for adjusting the inclination angle to an angle at which the phase difference is optimally compensated or may be designed to have the optimum inclination angle according to the pretilt angle of the liquid crystal 105. The optical compensation plate 201 is formed of, for example, an inorganic material. As the inorganic material, for example, an oxide containing at least one of Si, Al, Cr, Ti, and Zr is used. Alternatively, the optical compensation plate 201 may be formed of an inorganic material such as resin. In addition, the optical compensation plate 201 is not limited to only a C plate, but may be a combination of a C plate and at least one or more O plates, for example. In the case of combining the C plate and two O plates, it is not necessary to tilt the substrate and it is also possible to carry out the compensation by adjusting the O plate substrate normal line as the rotation axis.

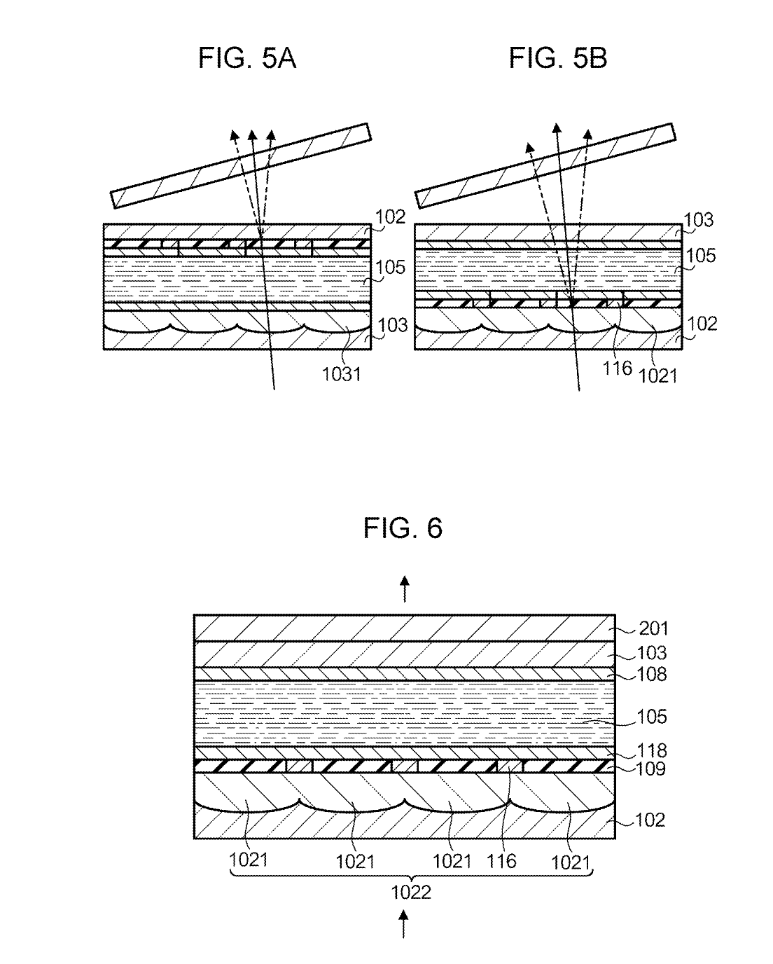

FIGS. 5A and 5B are diagrams comparing the optical path in the liquid crystal panel 100 with the comparative example. FIG. 5A schematically shows a light compensation effect in a liquid crystal panel according to a comparative example, FIG. 5B shows a liquid crystal panel 100 according to the present embodiment, and FIG. 4 schematically shows the light compensation effect. In the comparative example, a microlens array 1032 is formed on the counter substrate 103, light from the light source is incident from the counter substrate 103 and is emitted from the element substrate 102. Ideally, the direction in which light is transmitted through the liquid crystal 105 is the same as the direction in which the light is transmitted through the optical compensation plate 201; however, in the comparative example, light is diffracted by the structure (TFT 116 or the like) on the element substrate 102, a plurality diffraction peaks, that is, optical paths passing through the optical compensation plate 201, are generated with respect to the optical path of a certain light transmitted through the liquid crystal 105. The optical compensation plate 201 is designed so as to compensate for the light path change (optical characteristic) undergone by the light transmitted through the liquid crystal 105 due to the liquid crystal 105. Accordingly, when the light transmitted through the liquid crystal 105 is diffracted afterward, the compensation effect for diffraction light (arrow indicated by a dotted line in the figure) is not as large as the zero-order light (indicated by the solid arrow in the figure). Since light incident to the liquid crystal panel from the light source has an angular distribution of, for example, about 10°, this phenomenon occurs for light in each direction. Therefore, the compensation effect by the optical compensation plate 201 may not be sufficiently obtained in some cases.

The diffraction phenomenon on the element substrate 102 becomes more conspicuous as miniaturization and increasingly higher definition are achieved and the spacing between adjacent pixels 111, that is, the pixel pitch, becomes narrower. That is, as the pixel pitch becomes narrower, the intensity of diffracted light becomes stronger and the diffraction angle becomes larger. As an example, in a case where light having a wavelength of 550 nm is incident at an incident angle of 5°, the diffraction angles of the first order diffracted light are 1.3° and 8.7° when the pitch is 8.5 μm, the diffraction angles of the first order diffracted light are −0.3° and 10.3° when the pitch is 6 μm, and the diffraction angles of the first order diffracted light are −2.9° and 13.0° when the pitch is 4 μm.

On the other hand, in the present embodiment, as shown in FIG. 5B, light including diffracted light (dotted line arrow in the diagram) diffracted on the element substrate 102 is incident to the liquid crystal 105 and light emitted from the liquid crystal 105 is incident to the optical compensation plate 201 as it is without being diffracted. That is, for each light transmitted through the liquid crystal 105, it is possible to match the angle at which the light is transmitted through the liquid crystal 105 with the angle at which the light is transmitted through the optical compensation plate 201, and to improve the light compensation effect.

### 2. MODIFICATION EXAMPLES

The invention is not limited to the above-described embodiments, and various modifications are possible. Several Modification Examples will be described below. Two or more of the following Modification Examples may be used in combination.

FIG. 6 is a diagram illustrating the structure of the liquid crystal panel 100 according to Modification Example 1. In this example, the details of the optical compensation plate 201 in the liquid crystal panel 100 are different from the configuration of FIG. 4. The optical compensation plate 201 is formed by stacking two layers of so-called O plates and a C plate. The O plate is an optical member in which the refractive index ellipsoid is inclined as viewed from the in-plane direction and the thickness direction. In the case of a uniaxial phase difference plate, for example, for the refractive index relationship of the dimensional directions, the substrate normal line is set as the z direction and the refractive index relationship of the x direction and y direction in the substrate plane is nx>ny=nz; however, the ellipsoid itself is inclined as viewed from the thickness direction. In the case of a biaxial phase difference plate, the refractive indices in the three-dimensional directions are all different, and this three-dimensional ellipsoid is inclined with respect to the substrate normal line.

The O plate may be a uniaxial phase difference plate or a biaxial phase difference plate. The O plate is formed by oblique deposition of an inorganic material and the C plate is formed by sputtering an inorganic material.

In addition, in this example, the optical compensation plate 201 also serves as a dust-proof glass and is adhered to the counter substrate 103. Compared to the configuration of FIG. 4, it is possible to reduce the arrangement space of the optical compensation plate 201, that is, to save space. The dust-proof glass does not deteriorate the display quality even when dust adheres to the liquid crystal panel 100 in a case where the electro-optical apparatus is incorporated in a projection apparatus such as the projector 2100 which is electronic equipment.

Here, the optical compensation plate 201 is not limited to a plate in which two layers of O plates and a C plate are stacked. The optical compensation plate 201 may be a plate in which one layer of an O plate which is a uniaxial phase difference plate or an O plate which is a biaxial phase difference plate is stacked with a C plate.

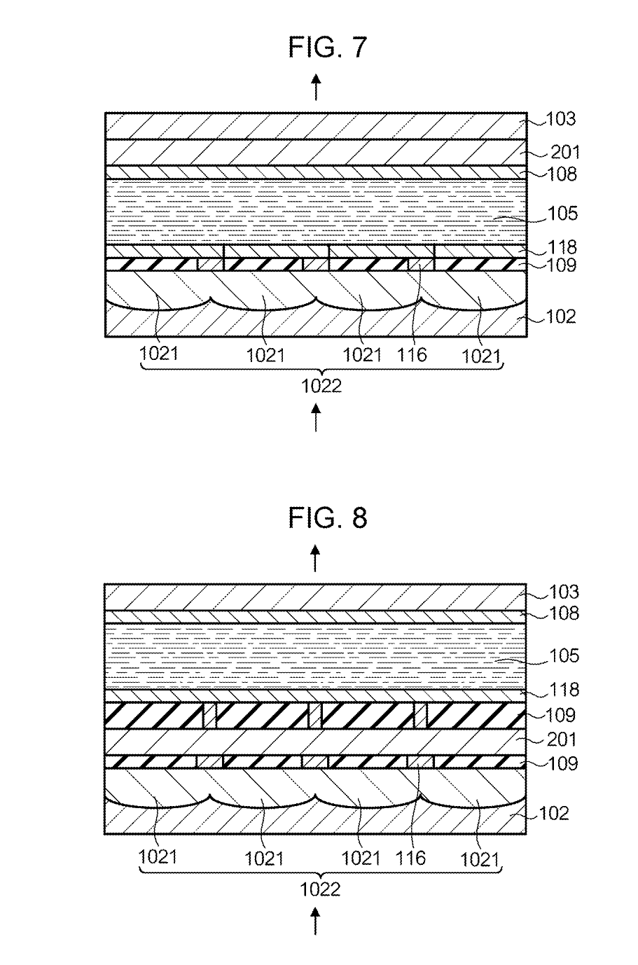

FIG. 7 is a diagram illustrating the structure of the liquid crystal panel 100 according to Modification Example 2. In this example, the optical compensation plate 201 is formed between the counter substrate 103 and the common electrode 108.

FIG. 8 is a diagram illustrating the structure of the liquid crystal panel 100 according to Modification Example 3. In this example, the optical compensation plate 201 is formed between the element substrate 102 and the liquid crystal 105 (more specifically, the pixel electrode 118). As illustrated in FIGS. 7 and 8, the liquid crystal panel 100 may have any structure as long as the optical compensation plate 201 is positioned downstream of the element substrate 102 in the optical path.

The liquid crystal is not limited to a VA mode liquid crystal. A TN liquid crystal or other mode liquid crystal may be used. Alternatively, an electro-optical layer other than liquid crystal may be used. In addition, the liquid crystal panel 100 is not limited to a panel used for the light valve of the projector. The liquid crystal panel 100 may be used for a direct-view display apparatus.

### Second Embodiment

### Liquid Crystal Apparatus

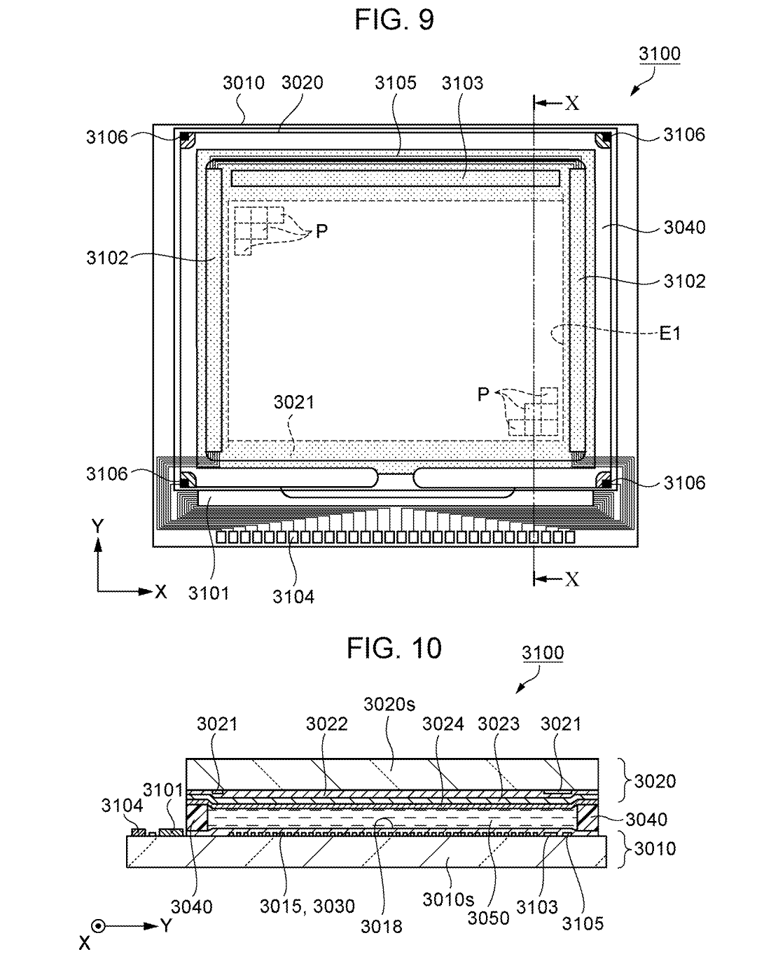

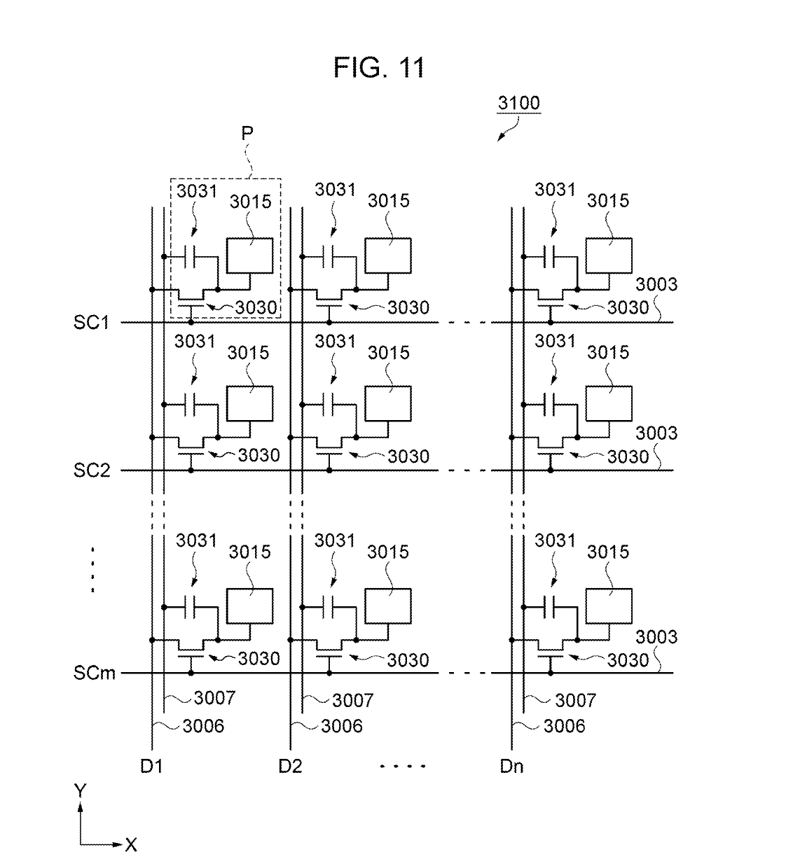

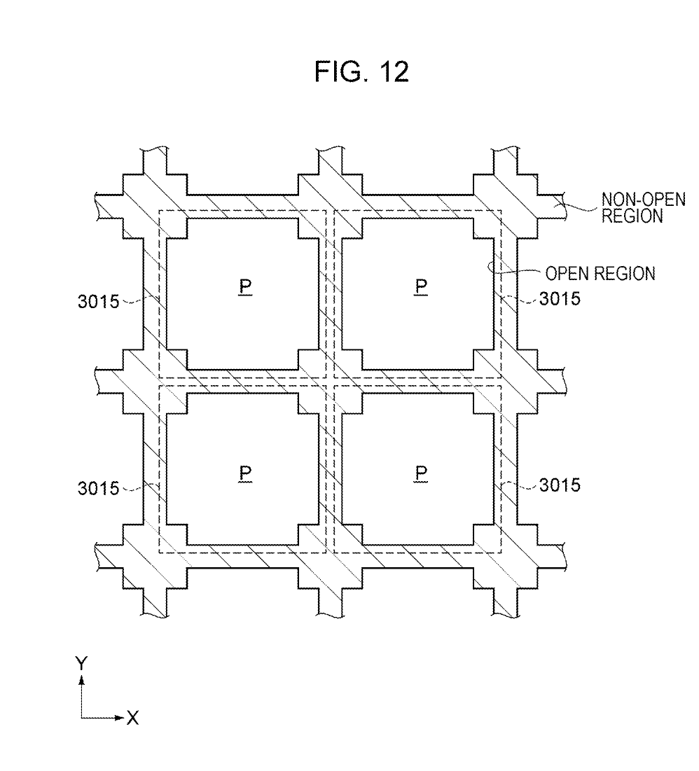

First, description will be given of the outline of the liquid crystal apparatus of the present embodiment with reference to FIGS. 9 to 12. FIG. 9 is a schematic planar diagram showing the configuration of the liquid crystal apparatus, FIG. 10 is a schematic cross-sectional diagram showing the structure of the liquid crystal apparatus along the line IX-IX in FIG. 9, and FIG. 11 is a circuit showing the electrical configuration of the liquid crystal apparatus, and FIG. 12 is a schematic planar diagram showing the arrangement of pixels in the liquid crystal apparatus. The liquid crystal apparatus of the present embodiment is suitably used as a light modulation means (liquid crystal light valve) in a projection-type display apparatus (liquid crystal projector) to be described below.

As shown in FIGS. 9 and 10, the liquid crystal apparatus 3100 of the present embodiment includes an element substrate 3010 and a counter substrate 3020 which are arranged to face each other, and a liquid crystal layer 3050 interposed between the pair of substrates. For a base material 3010s of the element substrate 3010 and a base material 3020s of the counter substrate 3020, a light-transmitting quartz substrate, a glass substrate, or the like is used, for example. Here, the element substrate 3010 corresponds to the first substrate in the invention and the counter substrate 3020 corresponds to the second substrate in the invention. Further, the light-transmitting property in this specification refers to a property that at least 85% or more of the light having a wavelength in the visible light region is able to be transmitted.

The element substrate 3010 is slightly larger than the counter substrate 3020. The element substrate 3010 and the counter substrate 3020 are bonded to each other via a sealing material 3040 arranged in a frame shape along the outer edge portion of the counter substrate 3020, and liquid crystal having negative dielectric anisotropy is sealed in the gap to form a liquid crystal layer 3050. As the sealing material 3040, for example, an adhesive such as a thermosetting or ultraviolet curable epoxy resin is adopted. A spacer (not shown) for keeping the distance between the pair of substrates constant is mixed in the sealing material 3040.

A display region E1 in which a plurality of pixels P are arranged in a matrix is provided in the sealing material 3040. In the counter substrate 3020, a partition portion 3021 surrounding the display region E1 is provided between the sealing material 3040 and the display region E1. The partition portion 3021 is made of, for example, a light-shielding metal, a metal oxide, or the like. Here, the display region E1 may include dummy pixels arranged so as to surround the plurality of pixels P in addition to the plurality of pixels P contributing to the display.

The element substrate 3010 is provided with a terminal portion where a plurality of external connection terminals 3104 are arranged. A data line driving circuit 3101 is provided between the first side portion along the terminal portion described above of the element substrate 3010 and the sealing material 3040. An inspection circuit 3103 is provided between the sealing material 3040 and the display region E along the second side portion opposite to the first side portion. Further, a scanning line driving circuit 3102 is provided between the sealing material 3040 along the third side and the fourth side which are orthogonal to the first side and opposed to each other and the display region E1. Between the sealing material 3040 of the second side portion and the inspection circuit 3103, a plurality of wirings 3105 connecting the two scanning line driving circuits 3102 are provided.

The wirings connected to the data line driving circuit 3101 and the scanning line driving circuit 3102 are connected to a plurality of external connection terminals 3104 arranged along the first side portion. Below, description will be given with the direction along the first side portion as the X direction, and the direction along the third side portion and the fourth side portion as the Y direction. Further, in this specification, viewing the element substrate 3010 and the counter substrate 3020 from a direction orthogonal to the X direction and the Y direction is referred to as “plan view” or “planar”.

As shown in FIG. 10, the element substrate 3010 includes a base material 3010s, a pixel electrode 3015 formed on the surface of the base material 3010s on the liquid crystal layer 3050 side, an alignment film 3018 covering the pixel electrode 3015, a thin film transistor (TFT) 3030 as a transistor related to the switching control of a pixel electrode 3015, and the like. The pixel electrode 3015 and the TFT 3030 are constituent elements of the pixel P.

The counter substrate 3020 includes a base material 3020s, and a partition portion 3021, a planarization layer 3022, a common electrode 3023, an alignment film 3024, and the like which are sequentially stacked on the surface of the base material 3020s on the side of the liquid crystal layer 3050.

As shown in FIG. 9, the partition portion 3021 surrounds the display region E1 and is provided at a position overlapping the scanning line driving circuit 3102 and the inspection circuit 3103 in plan view. Due to this, the partition portion 3021 has a role of blocking the light incident to the peripheral circuit including these driving circuits from the side of the counter substrate 3020 and preventing the peripheral circuit from malfunctioning due to light. Further, unnecessary stray light is blocked so as not to be incident to the display region E1, and a high contrast is secured in the display of the display region E1.

The planarization layer 3022 is formed of an inorganic material such as silicon oxide, for example, and is provided so as to cover the partition portion 3021 with transparency. The planarization layer 3022 is a silicon oxide film formed by using, for example, a plasma CVD method or the like, and has a thickness sufficient to be able to mitigate the surface unevenness of the common electrode 3023 formed on the planarization layer 3022.

The common electrode 3023 is formed of a transparent conductive film such as, for example, Indium Tin Oxide (ITO) or Indium Zinc Oxide (IZO), covers the planarization layer 3022, and is electrically connected to the wiring on the element substrate 3010 side by a vertical conductive portion 3106 provided at the four corners of the counter substrate 3020 as shown in FIG. 9.

The alignment film 3018 covering the pixel electrode 3015 and the alignment film 3024 covering the common electrode 3023 are set based on the optical design of the liquid crystal apparatus 3100, and an obliquely evaporated film (inorganic alignment film) of an inorganic material such as silicon oxide is adopted, and the alignment treatment of the liquid crystal layer 3050 creates substantially uniaxial vertical alignment (VA). As the alignment films 3018 and 3024, an organic alignment film of polyimide or the like may be adopted in addition to the inorganic alignment film.

The liquid crystal apparatus 3100 is a transmissive type, and an optical design of a normally white mode in which the pixel P is in a bright display state when it is not driven or a normally black mode in which the pixel P is in a dark display when not driven is adopted. Light-polarizing elements are used by being arranged on the light incident side and the light emission side, respectively, according to the optical design.

Next, description will be given of the electrical configuration of the liquid crystal apparatus 3100 with reference to FIG. 11. The liquid crystal apparatus 3100 includes a plurality of scanning lines 3003 and a plurality of data lines 3006 which are insulated from each other and orthogonal to each other in at least the display region E1, and capacitor lines 3007.

In a region partitioned by the scanning lines 3003 and the data lines 3006, a pixel electrode 3015, a TFT 3030, and a storage capacitor 3031 are provided, and these form a pixel circuit of the pixel P.

The scanning lines 3003 are electrically connected to the gate of the TFT 3030, the data lines 3006 are electrically connected to the first source/drain region of the TFT 3030, and the pixel electrode 3015 is electrically connected to the second source/drain region of the TFT 3030.

The data lines 3006 are connected to the data line driving circuit 3101 (see FIG. 9). The image signals D1, D2, . . . , Dn are supplied from the data line driving circuit 3101 to each pixel P via the data lines 3006. The scanning lines 3003 are connected to the scanning line driving circuit 3102 (see FIG. 9). The scanning signals SC1, SC2, SCm are supplied from the scanning line driving circuit 3102 to each pixel P via the scanning lines 3003.

The image signals D1 to Dn supplied from the data line driving circuit 3101 may be supplied to the data lines 3006 in a line sequential order in this order or may be supplied to each of the plurality of adjacent data lines 3006 for each group. The scanning line driving circuit 3102 sequentially supplies the scanning signals SC1 to SCm to the scanning line 3003 line-sequentially in a pulse manner at a predetermined timing.

In the configuration of the liquid crystal apparatus 3100, the TFT 3030, which is a switching element, is turned on for a certain period of time by the input of the scanning signals SC1 to SCm, so that the image signals D1 to Dn supplied from the data line 3006 are written in the pixel electrode 3015 at a predetermined timing. Image signals D1 to Dn of a predetermined level written in the liquid crystal layer 3050 via the pixel electrode 3015 are held for a certain period between the pixel electrode 3015 and the common electrode 3023.

In order to prevent the retained image signals D1 to Dn from leaking, the storage capacitor 3031 is connected in parallel with the liquid crystal capacitance formed between the pixel electrode 3015 and the common electrode 3023.

Here, a data line 3006 is connected to the inspection circuit 3103 shown in FIG. 9 and detecting the image signal described above makes it possible to detect operation defects or the like in the liquid crystal apparatus 3100 in the process of manufacturing the liquid crystal apparatus 3100; however, this configuration is omitted in the equivalent circuit of FIG. 11.

In addition, the peripheral circuit including the data line driving circuit 3101 and the scanning line driving circuit 3102 related to driving the pixel circuit of the pixel P may include a sampling circuit which samples the image signal described above and supplies the sampled image signal to the data line 3006, and a pre-charge circuit for supplying a pre-charge signal of a predetermined voltage level to the data line 3006 before the image signal.

Next, the configuration of the pixel P in the liquid crystal apparatus 3100 will be described with reference to FIG. 12. As shown in FIG. 12, the pixel P in the liquid crystal apparatus 3100 has, for example, a substantially rectangular open region in plan view. The open region is surrounded by a light-shielding non-open region extending in the X direction and the Y direction and provided in a lattice shape.

In the non-open region extending in the X direction, the scanning lines 3003 shown in FIG. 11 are provided. As the scanning lines 3003, a light-shielding conductive member is used, and a portion of the non-open region is formed by the scanning lines 3003.

Likewise, in the non-open region extending in the Y direction, the data lines 3006 and the capacitor lines 3007 shown in FIG. 11 are provided. A light-shielding conductive member is also used for the data lines 3006 and the capacitor lines 3007 so as to form a portion of the non-open region.

The TFT 3030 and the storage capacitor 3031 are provided so as to overlap at the intersection of the non-open region. Although the structure of the pixel P will be described below, in terms of the relationship between the TFT 3030 and the storage capacitor 3031 provided at the intersection, the width in the X direction and the Y direction at the intersection of the non-open region is wider than the width of the non-open region extending in the X direction or the Y direction. Providing the TFT 3030 at the intersection of the non-open region having the light-shielding property blocks the light incident to the TFT 3030 and secures the aperture ratio in the open region.

The pixel electrode 3015 is substantially square in plan view and is provided in the open region so that the outer edge of the pixel electrode 3015 overlaps the non-open region.

The liquid crystal apparatus 3100 of the present embodiment is a transmissive type in which the pixels P are formed on the premise that light is incident from the element substrate 3010 side. In addition, in order to effectively utilize incident light, microlenses are provided for each pixel P on the element substrate 3010. Furthermore, the liquid crystal apparatus 3100 has an optical compensation plate which compensates for the phase difference caused by light being transmitted through the liquid crystal layer 3050. Description will be given below of the structure of the pixel P provided with the microlens and the optical compensation plate.

### Pixel Structure

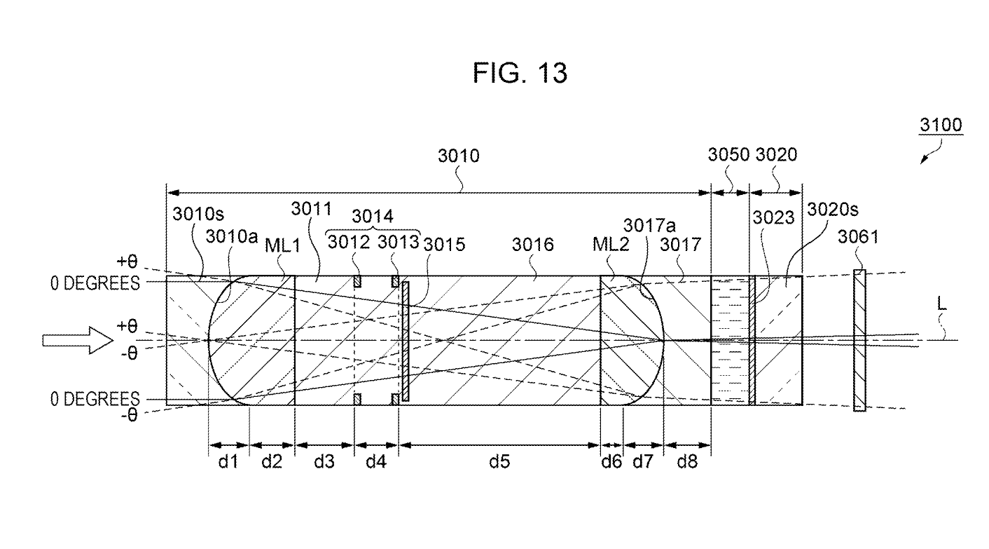

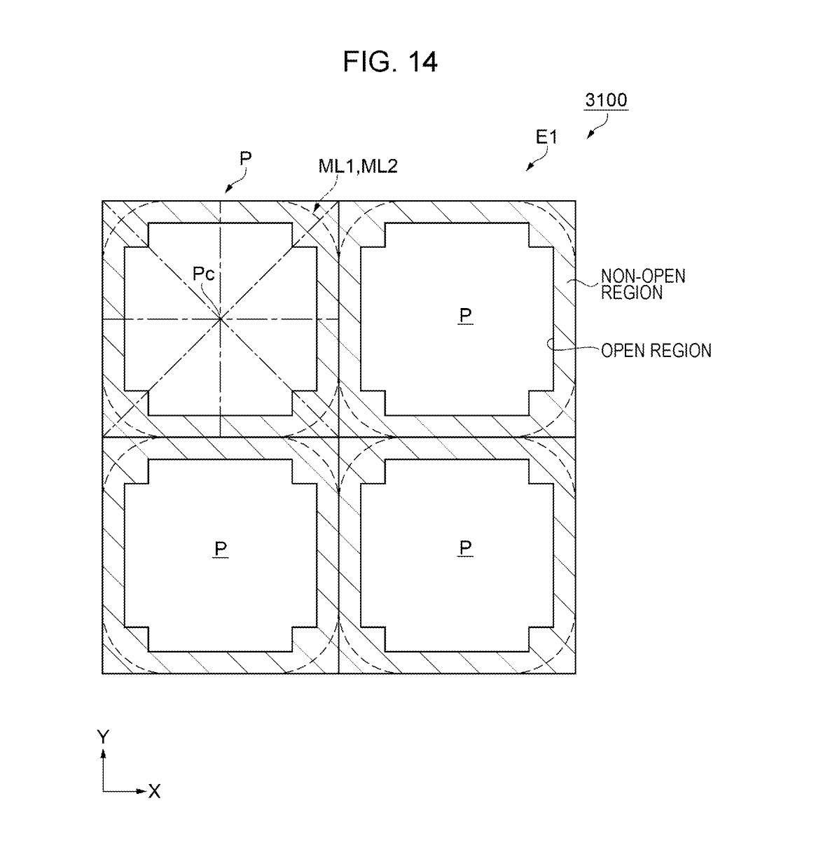

FIG. 13 is a schematic cross-sectional diagram showing the structure of a pixel in the liquid crystal apparatus of the second embodiment, and FIG. 14 is a schematic planar diagram showing the arrangement of microlenses in the pixel. Here, FIG. 13 schematically shows the structure of the pixel P in the display region E1, in which light is incident in the direction indicated by the arrow.

As shown in FIG. 13, in the liquid crystal apparatus 3100, the element substrate 3010 includes a first microlens ML1 having a convex lens surface 3010a on the light incident side, and a second microlens ML2 having a convex lens surface 3017a on the light emission side. The first microlens ML1 is in contact with the base material 3010s of the element substrate 3010. In other words, the boundary between the base material 3010s and the first microlens ML1 is the lens surface 3010a.

Between the first microlens ML1 and the second microlens ML2, the first light-transmitting layer 3011, the TFT layer 3014, the pixel electrode 3015, and the second light-transmitting layer 3016 are provided from the side of the first microlens ML1. A third light-transmitting layer 3017 is provided between the second microlens ML2 and the liquid crystal layer 3050. The boundary between the second microlens ML2 and the third light-transmitting layer 3017 is a lens surface 3017a.

The TFT layer 3014 has a first light-shielding portion 3012 and a second light-shielding portion 3013 which define a non-open region surrounding the open region of the pixel P illustrated in FIG. 12. The first light-shielding portion 3012 and the second light-shielding portion 3013 are provided so as to be separated from each other in the incident direction of the light. The first light-shielding portion 3012 and the second light-shielding portion 3013 are wiring layers on which wirings such as the scanning lines 3003, the data lines 3006, the capacitor lines 3007 and the like connected to the TFT 3030 on the element substrate 3010 are formed and, although not shown in FIG. 13, the TFT 3030 is formed between the first light-shielding portion 3012 and the second light-shielding portion 3013. Thus, the TFT 3030 is shielded from light by at least the first light-shielding portion 3012. In the invention, the TFT layer 3014 is an example of a wiring layer provided with a transistor.

A counter substrate 3020 having a common electrode 3023 is arranged with respect to the element substrate 3010 to interpose a liquid crystal layer 3050. On the light emission side of the counter substrate 3020, an optical compensation plate 3061 is provided at a position separated from the counter substrate 3020.

Examples of a manufacturing method of the element substrate 3010 having the first microlens ML1 and the second microlens ML2 arranged with the TFT layer 3014 interposed therebetween include the following method. An example of a method of manufacturing the element substrate 3010 includes a first step of isotropically etching the surface of the base material 3010s made of quartz or the like opposite to the light incident side so as to form the lens surface 3010a, a second step of filling the lens surface 3010a using a lens material having a larger refractive index than that of the base material 3010s to form a lens material layer, a third step of planarizing the surface unevenness of the lens material layer to form a lens layer (first microlens ML1), a fourth step of forming a first light-transmitting layer 3011 on the planarized lens layer (first microlens ML1), a fifth step of forming a TFT layer 3014 on the first light-transmitting layer 3011, and a sixth step of forming a pixel electrode 3015. In addition, the method has a seventh step of forming a second light-transmitting layer 3016 by stacking on the pixel electrode 3015, an eighth step of forming a lens material layer on the second light-transmitting layer 3016 using a lens material having a larger refractive index than that of the second light-transmitting layer 3016, a ninth step of forming a resist layer patterned corresponding to the size of the second microlens ML2 in the lens material layer, a tenth step of forming a curved surface on the resist layer by carrying out a heating treatment on the resist layer, an eleventh step of dry etching the lens material layer and the resist layer to form a lens layer (a second microlens ML2), a twelfth step of forming a light-transmitting material layer covering the lens layer (the second microlens ML2) using a light-transmitting material with a smaller refractive index than the lens layer (second microlens ML2), and a thirteenth step of forming a third light-transmitting layer 3017 by planarizing the unevenness of the surface of the light-transmitting material layer.

More specifically, in the first step, a control film formed of an oxide film such as SiO₂ is formed on one surface of a base material 3010s made of quartz or the like. The etching rate of the control film in the isotropic etching is different from that of the base material 3010s, and the control film has a function of adjusting the etching rate in the width direction (X direction and Y direction) with respect to the etching rate in the depth direction at the time of forming the lens surface 3010a.

Next, a mask layer is formed on the control film. Then, the mask layer is patterned to form an opening in the mask layer. The planar center position of this opening portion is the planar center of the lens surface 3010a. Subsequently, isotropic etching is carried out on the base material 3010s covered with the control film via the opening portion of the mask layer. Due to this, the base material 3010s is isotropically etched through the opening portion to form a lens surface 3010a having a substantially hemispherical shape.

Examples of a lens material having a refractive index larger than that of the base material 3010s include silicon oxynitride (SiO₂-xNx), aluminum oxide (Al₂O₃), or the like. With silicon oxynitride, it is possible to change the refractive index by adjusting the content ratio of nitrogen to oxygen. Incidentally, the refractive index of SiO₂ is approximately 1.46, the refractive index of SiON is approximately 1.64, and the refractive index of Al₂O₃ is approximately 1.77. Examples of the method of forming the lens material layer include a plasma CVD method or the like (second step and eighth step).

Examples of the planarizing method of the lens material layer and the light-transmitting material layer include a chemical mechanical polishing (CMP) treatment and an etching treatment (third step and thirteenth step).

Examples of a method of forming the first light-transmitting layer 3011, the second light-transmitting layer 3016, and the third light-transmitting layer 3017 having the approximately the same refractive index as the refractive index of the base material 3010s include a method of forming a film by depositing an oxide such as SiO₂ using a plasma CVD method or the like (fourth step, seventh step, and twelfth step).

In the fifth step, the TFT 3030 and wirings and the like connected to the TFT 3030 are formed using a known method. In the present embodiment, the semiconductor layer of the TFT 3030 is formed using high-temperature polysilicon, and the TFT 3030 having a semiconductor layer with a Lightly Doped Drain (LDD) structure is formed by implanting impurity ions into the semiconductor layer. An interlayer insulating film formed of an oxide such as SiO₂ is formed between the semiconductor layer and the wiring.

In the sixth step, a transparent conductive film formed by a sputtering method or the like using a metal oxide such as Indium Tin Oxide (ITO) or Indium Zinc Oxide (IZO) is patterned to form a pixel electrode 3015.

In the tenth step, the resist layer patterned in the ninth step is subjected to a heat treatment to soften (melt) the resist layer, and the resist layer is deformed into a curved surface by the surface tension and then cooled to be hardened. By dry etching the resist layer deformed into a curved surface in the eleventh step and the lens material layer which is the layer under the resist layer, the lens material layer on which the curved surface is etched and transferred, that is, the lens layer, is formed.

The length on the optical axis L of each of the first microlens ML1, the first light-transmitting layer 3011, the TFT layer 3014, the second light-transmitting layer 3016, the second microlens ML2, and the third light-transmitting layer 3017, and the refractive index are for example, as shown in the following Table 1.

Here, the length of the lens surface 3010a of the first microlens ML1 is d1, and the length of the other portions is d2. The length of the first light-transmitting layer 3011 is d3, the length of the TFT layer 3014 is d4, and the length of the second light-transmitting layer 3016 is d5. The length of the lens surface 3017a of the second microlens ML2 is d7, and the length of the other portions is d6. The length of the third light-transmitting layer 3017 is d8.

TABLE 1

| | Length (μm) | Refractivity |
|---|---|---|
| d1 | 3.20 | 1.64 |
| d2 | 1.00 | 1.64 |
| d3 | 5.00 | 1.46 |
| d4 | 2.77 | 1.46 |
| d5 | 11.90 | 1.50 |
| d6 | 3.00 | 1.64 |
| d7 | 3.20 | 1.64 |
| d8 | 10.00 | 1.46 |

According to the structure of the pixel P as described above, as shown in FIG. 13, light parallel to the optical axis L incident along the optical axis L (the incident angle to the element substrate 3010 is 0 degrees) is refracted by the first microlens ML1 in the direction of the convergence (convergence) to pass through the open region of the TFT layer 3014, and the light incident to the second microlens ML2 and refracted in the convergence direction by the second microlens ML2 is refracted into light of approximately the original angle to be incident to the liquid crystal layer 3050. More specifically, light parallel to the optical axis L is refracted at an angle with respect to a normal line orthogonal to a plane (boundary surface) contacting the incident point on the lens surface 3010a of the first microlens ML1 and an angle of 0+α (or 0−α) depending on the refractive index of the base material 3010s and the first microlens ML1. Accordingly, the amount of light incident and lost on the TFT layer 3014 (the first light-shielding portion 3012 and the second light-shielding portion 3013) is reduced. In addition, the light refracted to the angle of 0+α (or 0−α) is refracted to an angle with respect to the normal line orthogonal to the plane (boundary surface) contacting the incident point on the lens surface 3017a of the second microlens ML2 and an angle corresponding to the refractive index of the second microlens ML2 and the third light-transmitting layer 3017. Here, the curvature and the refractive index of the second microlens ML2 are adjusted by the second microlens ML2 so as to refract light to have an angle substantially parallel to the optical axis L.

On the other hand, the light incident from an oblique direction with respect to the optical axis L (the incident angle to the element substrate 3010 is ±θ degrees) is condensed by the first microlens ML1 to pass through the open region of the TFT layer 3014, is incident to the second microlens ML2, is refracted to approximately the original angle with respect to the optical axis L, and is incident to the liquid crystal layer 3050. More specifically, light having an angle of +θ (or −θ) with respect to the optical axis L is refracted to an angle with respect to a normal line orthogonal to a plane (boundary surface) in contact with the incident point on the lens surface 3010a of the first microlens ML1 and to an angle of +θ+α (or −θ−α) depending on the refractive index of the base material 3010s and the first microlens ML1. Accordingly, the amount of light incident and lost on the TFT layer 3014 (the first light-shielding portion 3012 and the second light-shielding portion 3013) is reduced. In addition, light refracted by the first microlens ML1 at an angle of +θ+α (or −θ−α) is refracted at an angle with respect to a normal line orthogonal to a plane (boundary surface) contacting the incident point on the lens surface 3017a of the second microlens ML2 and is refracted as light having an original angle of approximately +θ (or −θ) with respect to the optical axis L depending on the refractive index of the second microlens ML2 and the third light-transmitting layer 3017. Here, adjusting the curvature and the refractive index of the second microlens ML2 makes it possible to make the refracted light more closely parallel to the optical axis L.

The incident angle range (0±θ degrees) of the light which is transmitted through the open region of the TFT layer 3014 depends on the condensing ability of the first microlens ML1. The condensing ability depends on the curvature and the refractive index of the lens surface 3010a of the first microlens ML1. Here, the refractive index also varies depending on the wavelength of light. In the present embodiment, the first microlens ML1 is formed so that the incident angle range with respect to the element substrate 3010 is, for example, 0±18 degrees. In addition, the second microlens ML2 is formed such that light having an incident angle of 0±18 degrees incident to the first microlens ML1 is able to be converted to light of approximately 0±18 degrees of the original angle by the second microlens ML2.

As shown in FIG. 14, the pixel P has an open region surrounded by a non-open region. In the present embodiment, the planar shape of the pixel P including the non-open region is a square. Accordingly, the intersection point of the diagonal lines of the pixel P is the center Pc of the pixel P. The optical axis L of the light incident to the pixel P passes through the center Pc. The first microlens ML1 and the second microlens ML2 are formed in the element substrate 3010 such that the planar centers of the first microlens ML1 and the second microlens ML2 coincide with the center Pc of the pixel P. In addition, the first microlenses ML1 are formed so as to be in contact with each other in the pixels P adjacent in the X direction and the Y direction. The portion where the adjacent first microlenses ML1 are in contact is a straight line in a plan view and is positioned in the non-open region. A portion with which one adjacent microlens ML1 is not in contact is a curve in plan view and is also positioned in a non-open region. That is, a region formed by portions where the adjacent first microlenses ML1 are not in contact is a region without the first microlens ML1, and is positioned at the intersection of the non-open regions. That is, the light incident to the region without the first microlens ML1 is incident the non-open region and is blocked. The planar positional relationship between the second microlens ML2 and the pixel P having the open region and the non-open region is also the same as that of the first microlens ML1.

In the present embodiment, the planar shape of the pixel P is a square, but the shape is not limited thereto. In addition, the planar shape of the open region is not necessarily point symmetrical. Accordingly, the planar centers of the first microlens ML1 and the second microlens ML2 are preferably positioned at the center of gravity of the area in the open region of the pixel P from the viewpoint of effectively utilizing incident light.

As described above, in the display region E1, a plurality of pixels P are arranged in a matrix in the X direction and the Y direction (refer to FIG. 9). Accordingly, the first microlens ML1 and the second microlens ML2 are also arranged in a matrix in the X direction and the Y direction in the display region E1. In this manner, the first microlens ML1 arranged in a matrix is referred to as a first microlens array. Similarly, the second microlens ML2 arranged in a matrix is referred to as a second microlens array. The optical compensation plate 3061 is provided across at least the display region E1 corresponding to such a microlens array.

In the present embodiment, the liquid crystal layer 3050 is formed of liquid crystal molecules having negative dielectric anisotropy (refractive index anisotropy) subjected to substantially uniaxial vertical alignment treatment as described above. In the substantially vertical alignment treatment using the inorganic alignment film of the present embodiment, the liquid crystal molecules are aligned with a pretilt angle of approximately 3 to 5 degrees with respect to the normal line direction of the alignment film surface. In the liquid crystal apparatus 3100, a pair of light-polarizing elements having light-polarizing axes (transmission axes or absorption axes) intersecting with the direction of the substantially uniaxial vertical alignment treatment at an angle of 45 degrees are combined. As shown in FIG. 13, the light (linearly polarized light) transmitted through one light-polarizing element of the pair of light-polarizing elements is condensed by the first microlens ML1 and converted to light of the original angle by the second microlens ML2; however, the light transmitted through the liquid crystal layer 3050 includes light that is obliquely transmitted with respect to the optical axis L.

The light obliquely transmitted through the liquid crystal layer 3050 composed of liquid crystal molecules with respect to the optical axis L is shifted on the light-polarizing axis with respect to the light transmitted along the optical axis L, in other words, a phase difference is generated and the linearly polarized light becomes elliptically polarized light. Since the light transmitted through the liquid crystal layer 3050 includes elliptically polarized light as described above, light leakage occurs in, for example, a black display in which no electric field is applied to the liquid crystal layer 3050, so that the display contrast is lowered. Therefore, in the present embodiment, an optical compensation plate 3061 is provided which compensates for the phase difference due to the birefringence of the light transmitted through the liquid crystal layer 3050.

### Optical Compensation Plate

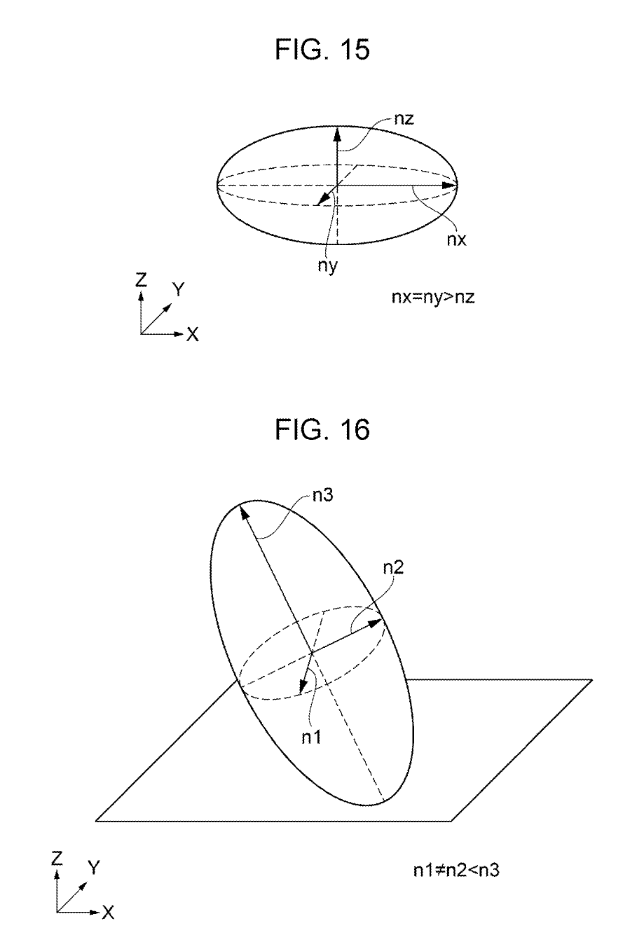

Description will be given of the optical compensation plate 3061 of the present embodiment with reference to FIGS. 15 and 16. FIG. 15 is a diagram showing an example of a C plate (refractive index ellipsoid) as an optical compensation plate, and FIG. 16 is a diagram showing an example of an 0 plate (refractive index ellipsoid) as an optical compensation plate.

As the optical compensation plate 3061, for example, it is possible to adopt a C plate as shown in FIG. 15. The C plate (refractive index ellipsoid) shown in FIG. 15 has a structure called a negative C plate in which the refractive indices nx, ny, nz of the optical axes (x, y, z) satisfy the relationship of nx=ny>nz. Since the liquid crystal molecules exhibiting negative dielectric anisotropy are considered to be optically positive C plates (satisfying the relation of nx=ny<nz), it is preferable to use a negative C plate as the optical compensation plate 3061 for compensating for the phase difference. The optical axes (x, y, z) of the negative C plate in FIG. 15 are displayed corresponding to the X direction, the Y direction, and the Z direction orthogonal to the X direction and the Y direction in this specification.

Since the liquid crystal molecules are aligned substantially vertically with a pretilt angle in the uniaxial direction as described above, from the viewpoint of compensating the phase difference related to the pretilt angle, it is preferable to arrange the optical compensation plate 3061 using a negative C plate to be inclined at an angle corresponding to the pretilt angle in the opposite direction to the direction in which the liquid crystal molecules are inclined according to the pretilt (the pretilt direction in the invention) with respect to the alignment surface where the slow axis of the refractive index nz is defined in the X direction and the Y direction. In addition to the phase difference caused by the light (linearly polarized light) being transmitted through the liquid crystal layer 3050 obliquely with respect to the optical axis L, a wider viewing angle characteristic is realized by compensating for the phase difference related to the pretilt of the liquid crystal molecules.

As the optical compensation plate 3061, for example, an O plate as shown in FIG. 16 may be adopted. In the O plate (refractive index ellipsoid) shown in FIG. 16, refractive indices n₁, n₂, n₃ of optical axes (1, 2, 3) satisfy a relationship of n₁≠n₂<n₃ and the slow axis of the largest refractive index n₃ is inclined. Accordingly, from the viewpoint of compensating for the phase difference related to the pretilt of the liquid crystal molecules in the substantially vertical alignment, the O plate is able to be arranged to be inclined at an angle corresponding to the pretilt angle in the opposite direction to the direction in which the liquid crystal molecules are inclined according to the pretilt with respect to the alignment surface where the slow axis of the refractive index n₃ is defined in the X direction and the Y direction. Here, since the value of the front phase difference of the O plate is larger than that of the C plate, in a case where the arrangement leads to overcompensation, the arrangement may be appropriately changed so that the optical compensation effect is increased.

In addition, as the optical compensation plate 3061, a C plate and an O plate may be used in combination according to the phase difference of the liquid crystal layer 3050.

It is possible to form such a C plate or O plate as an aggregate of columnar crystals having refractive index anisotropy by obliquely depositing silicon oxide (SiO₂), for example. Controlling the deposition direction and deposition angle in the oblique deposition makes it possible to define the direction and angle of the slow axis in the columnar crystal.

According to the second embodiment described above, the following effects are able to be obtained.

(1) The element substrate 3010 has, for each pixel P, a first microlens ML1 which condenses incident light and transmits the light through the open region of the TFT layer 3014, and a second microlens ML2 which converts the light collected by the first microlens ML1 into light at substantially the original angle and makes the light incident to the liquid crystal layer 3050. Since the first microlens ML1 and the second microlens ML2 are arranged with high positional precision with respect to the optical axis L, decreases in the utilization efficiency of light due to the positional shift between the first microlens ML1 and the second microlens ML2 are prevented and it is possible to realize a high light utilization efficiency. In addition, as compared with the case without the second microlens ML2, the angle of light obliquely transmitted through the liquid crystal layer 3050 becomes smaller. Furthermore, the phase difference of the light obliquely transmitted through the liquid crystal layer 3050 is compensated for by the optical compensation plate 3061 provided on the light emission side of the counter substrate 3020. That is, it is possible to improve the utilization efficiency of the incident light and the decrease in contrast due to the phase difference of the light obliquely transmitted through the liquid crystal layer 3050, and to provide the liquid crystal apparatus 3100 realizing excellent display quality.

(2) In the liquid crystal layer 3050, the liquid crystal molecules have a pretilt angle of about 3 to 5 degrees with respect to the alignment film surface and are aligned substantially vertically in one axis direction. The optical compensation plate 3061 is formed of a C plate, an O plate or a combination thereof, and the slow axis of the optical compensation plate 3061 is inclined at an angle corresponding to the pretilt angle in a direction opposite to the direction in which the liquid crystal molecules are tilted according to the pretilt, thus the phase difference related to the pretilt of the liquid crystal molecules is also compensated for in addition to the phase difference of the light obliquely transmitted through the liquid crystal layer 3050. Accordingly, it is possible to suppress the decrease in contrast due to such a phase difference over a wide viewing angle range. In other words, it is possible to provide the liquid crystal apparatus 3100 with improved viewing angle characteristics.

### Third Embodiment

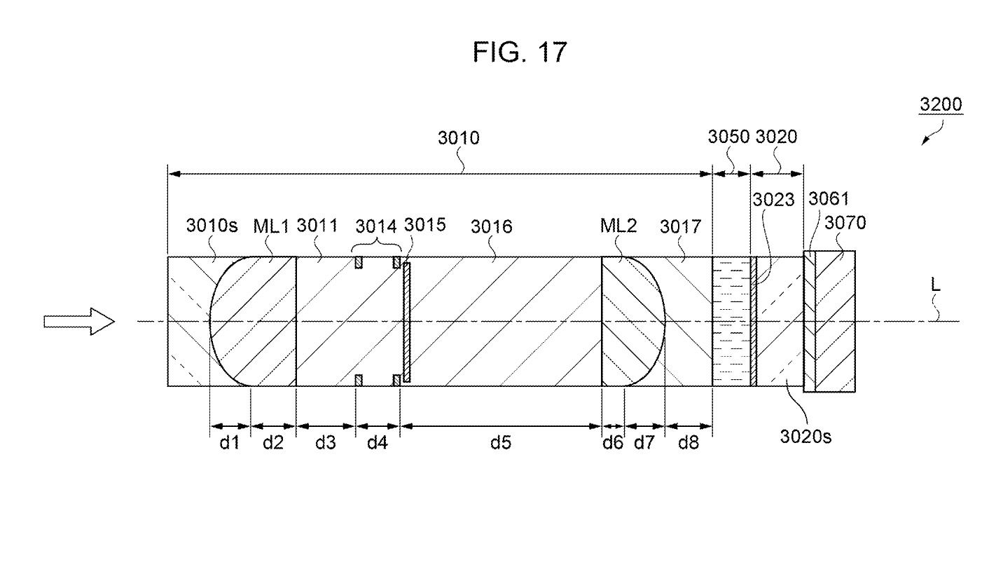

Next, description will be given of a liquid crystal apparatus according to a third embodiment with reference to FIG. 17. FIG. 17 is a schematic cross-sectional diagram showing the structure of a pixel in the liquid crystal apparatus of the third embodiment. The liquid crystal apparatus of the third embodiment is different from the liquid crystal apparatus 3100 of the second embodiment described above in the arrangement form of the optical compensation plate 3061. Accordingly, the same components as those of the liquid crystal apparatus 3100 are denoted by the same reference numerals, and a detailed description thereof will be omitted.

As shown in FIG. 17, in the liquid crystal apparatus 3200 of the present embodiment, a liquid crystal layer 3050 is interposed between an element substrate 3010 and a counter substrate 3020. For each pixel P, the element substrate 3010 on the side on which light is incident has a base material 3010s, a first microlens ML1, a first light-transmitting layer 3011, a TFT layer 3014, a pixel electrode 3015, a second light-transmitting layer 3016, a second microlens ML2, and a third light-transmitting layer 3017 from the light incident side. The counter substrate 3020 has a base material 3020s and a common electrode 3023 on the liquid crystal layer 3050 side of the base material 3020s. In addition, the liquid crystal apparatus 3200 includes a light-transmitting third substrate 3070 provided with an optical compensation plate 3061 on the light emission side of the counter substrate 3020.

In the case where the liquid crystal apparatus 3200 is used as a light modulation means of a projection-type display apparatus described below, the third substrate 3070 functions as a dust-proof substrate for preventing foreign matter attached to the surface of the counter substrate 3020 from being reflected on the projected display. In other words, the optical compensation plate 3061 is provided on the third substrate 3070 functioning as a dust-proof substrate. The dust-proof substrate is also arranged on the light incident side of the element substrate 3010.

The third substrate 3070 may be arranged so that the optical compensation plate 3061 is in close contact with the base material 3020s of the counter substrate 3020 or may be arranged such that the optical compensation plate 3061 and the base material 3020s face each other with a gap therebetween. In addition, the gap described above may be filled with a light-transmitting adhesive resin.

According to the third embodiment, in addition to the effects (1) and (2) of the second embodiment described above, the following effects are able to be obtained.

(3) Since the optical compensation plate 3061 is provided on the third substrate 3070 functioning as a dust-proof substrate, it is unnecessary to additionally prepare a support for the optical compensation plate 3061, and it is possible to adopt a simple structure.

### Fourth Embodiment

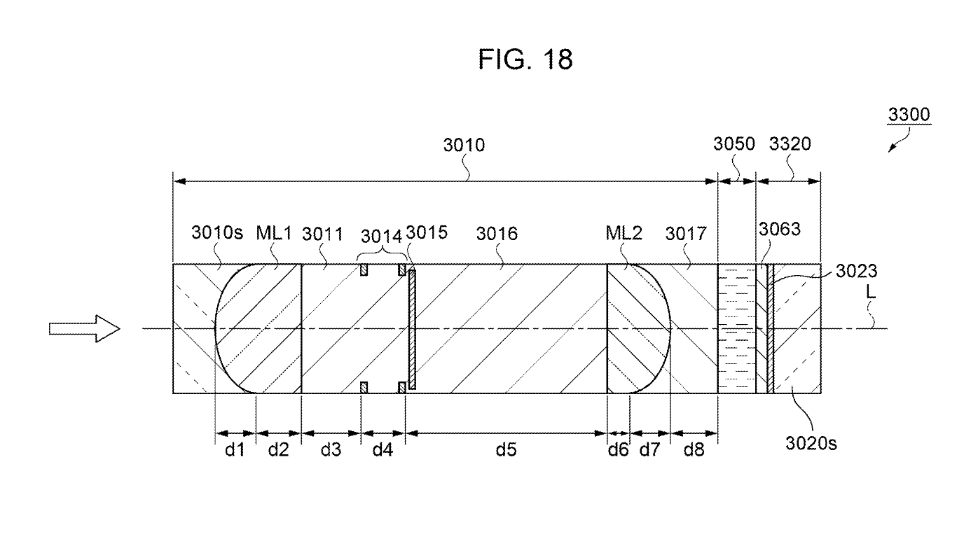

Next, description will be given of a liquid crystal apparatus according to a fourth embodiment with reference to FIG. 18. FIG. 18 is a schematic cross-sectional diagram showing the structure of a pixel in the liquid crystal apparatus of the fourth embodiment. The liquid crystal apparatus of the fourth embodiment is different from the liquid crystal apparatus 3100 of the second embodiment described above in the arrangement form of the optical compensation plate. Accordingly, the same components as in the liquid crystal apparatus 3100 are denoted by the same reference numerals, and a detailed description thereof will be omitted.

As shown in FIG. 18, in the liquid crystal apparatus 3300 of the present embodiment, a liquid crystal layer 3050 is interposed between an element substrate 3010 and a counter substrate 3320. For each pixel P, the element substrate 3010 on the side on which light is incident has a base material 3010s, a first microlens ML1, a first light-transmitting layer 3011, a TFT layer 3014, a pixel electrode 3015, a second light-transmitting layer 3016, a second microlens ML2, and a third light-transmitting layer 3017 from the light incident side. The counter substrate 3320 includes a base material 3020s, a common electrode 3023, and an optical compensation plate 3063 provided between the common electrode 3023 and the liquid crystal layer 3050. That is, the liquid crystal apparatus 3300 has a configuration in which the optical compensation plate 3063 is incorporated in the counter substrate 3320 with respect to the liquid crystal apparatus 3100 of the second embodiment described above.

As described above, it is possible to form the optical compensation plate 3063 as an aggregate of columnar crystals having refractive index anisotropy by obliquely depositing silicon oxide (SiO₂), for example. Although not shown in FIG. 18, an alignment film 3024 is present between the optical compensation plate 3063 and the liquid crystal layer 3050 (see FIG. 10). Since the alignment film 3024 is an inorganic alignment film, it is possible to form the optical compensation plate 3063 and the alignment film 3024 in the step of forming the alignment film 3024 on the common electrode 3023.

According to the fourth embodiment, in addition to the same effect as the effect (1) of the second embodiment described above, even if a dedicated manufacturing apparatus for forming the optical compensation plate 3063 is not introduced, it is possible to utilize the manufacturing apparatus which forms the alignment film 3024 and incorporating the optical compensation plate 3063 in the counter substrate 3320 makes it possible to provide a more compact liquid crystal apparatus 3300.

### Fifth Embodiment

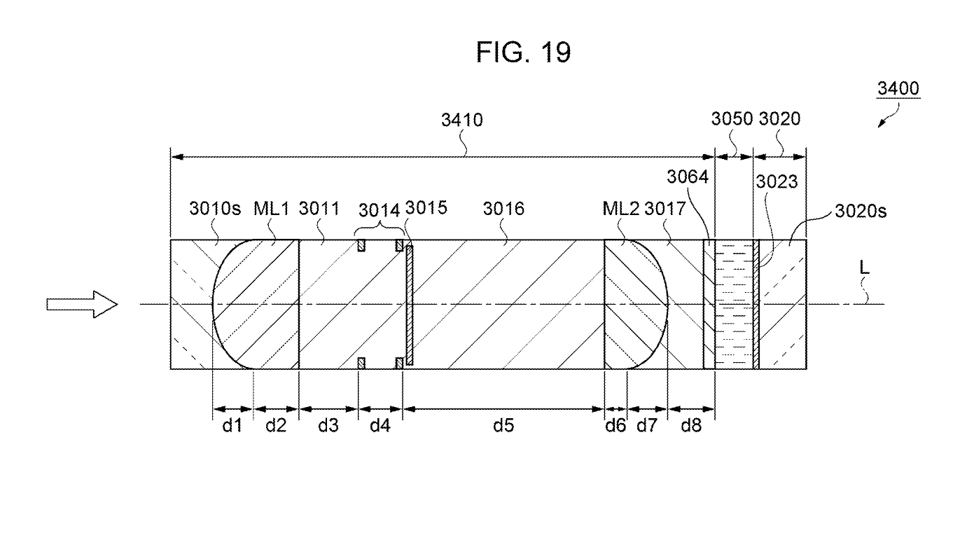

Next, description will be given of a liquid crystal apparatus according to a fifth embodiment with reference to FIG. 19. FIG. 19 is a schematic cross-sectional diagram showing the structure of a pixel in the liquid crystal apparatus of the fifth embodiment. The liquid crystal apparatus of the fifth embodiment is different from the liquid crystal apparatus 3100 of the second embodiment described above in the arrangement form of the optical compensation plate. Accordingly, the same components as in the liquid crystal apparatus 3100 are denoted by the same reference numerals, and a detailed description thereof will be omitted.

As shown in FIG. 19, in the liquid crystal apparatus 3400 of the present embodiment, a liquid crystal layer 3050 is interposed between an element substrate 3410 and a counter substrate 3020. For each pixel P, the element substrate 3410 on the side on which light is incident has a base material 3010s, a first microlens ML1, a first light-transmitting layer 3011, a TFT layer 3014, a pixel electrode 3015, a second light-transmitting layer 3016, a second microlens ML2, a third light-transmitting layer 3017, and an optical compensation plate 3064 from the light incident side. The counter substrate 3020 has a base material 3020s and a common electrode 3023 on the liquid crystal layer 3050 side of the base material 3020s. That is, the liquid crystal apparatus 3400 has a configuration in which an optical compensation plate 3064 is incorporated in the element substrate 3410 with respect to the liquid crystal apparatus 3100 of the second embodiment described above.

Similarly to the optical compensation plate 3063 of the fourth embodiment described above, the optical compensation plate 3064 is able to be formed of an aggregate of columnar crystals having refractive index anisotropy by obliquely depositing silicon oxide (SiO₂). Although not shown in FIG. 19, an alignment film 3018 is present between the optical compensation plate 3064 and the liquid crystal layer 3050 (refer to FIG. 10). Since the alignment film 3018 is also an inorganic alignment film like the alignment film 3024 on the counter substrate 3020 side, it is possible to form the optical compensation plate 3064 and the alignment film 3018 in the step of forming the alignment film 3018 on the pixel electrode 3015.

According to the fifth embodiment, in addition to the same effect as the effect (1) of the second embodiment described above, even if a dedicated manufacturing apparatus for forming the optical compensation plate 3064 is not introduced, it is possible to utilize the manufacturing apparatus which forms the alignment film 3018 and incorporating the optical compensation plate 3064 into the element substrate 3410 makes it possible to provide a more compact liquid crystal apparatus 3400.

### Sixth Embodiment

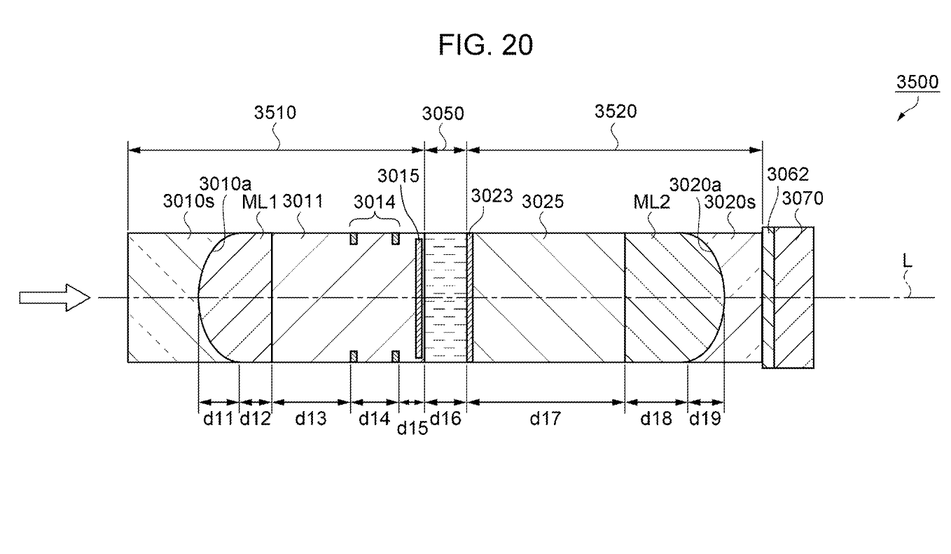

Next, a liquid crystal apparatus according to a sixth embodiment will be described with reference to FIG. 20. FIG. 20 is a schematic cross-sectional diagram showing the structure of a pixel in the liquid crystal apparatus of the sixth embodiment. The liquid crystal apparatus of the sixth embodiment is different from the liquid crystal apparatus 3200 of the third embodiment described above in the configuration of the element substrate 3010 and the counter substrate 3020. Accordingly, the same components as those of the liquid crystal apparatus 3200 are denoted by the same reference numerals, and a detailed description thereof will be omitted.

In the liquid crystal apparatus 3500 of the present embodiment, a liquid crystal layer 3050 is interposed between an element substrate 3510 and a counter substrate 3520. In addition, a third substrate 3070 provided with an optical compensation plate 3062 is arranged on the light emission side of the counter substrate 3520.

For each pixel P, the element substrate 3510 on the light incident side has the base material 3010s, the first microlens ML1, the first light-transmitting layer 3011, the TFT layer 3014, and the pixel electrode 3015 from the light incident side. Similarly, for each pixel P, the counter substrate 3520 has a common electrode 3023, a second light-transmitting layer 3025, a second microlens ML2, and a base material 3020s from the light incident side. That is, with respect to the liquid crystal apparatus 3200 of the third embodiment, the liquid crystal apparatus 3500 of the present embodiment has a configuration in which the first microlens ML1 and the second microlens ML2 are arranged with the TFT layer 3014 and the liquid crystal layer 3050 interposed therebetween.

An example of a method for manufacturing the element substrate 3510 has a first step of isotropically etching a surface of the base material 3010s made of quartz or the like on the opposite side to the light incident side to form the lens surface 3010a, a second step of filling the lens surface 3010a with a lens material having a refractive index larger than that of the base material 3010s to form a lens material layer, a third step of planarizing the unevenness of the surface of the lens material layer to form a lens layer (first microlens ML1), a fourth step of forming a first light-transmitting layer 3011 on the planarized lens layer (first microlens ML1), a fifth step of forming a TFT layer 3014 on the first light-transmitting layer 3011, and a sixth step of forming the pixel electrode 3015. In other words, it is possible for the first step to the sixth step to adopt the same method as the first step to the sixth step in the example of the method of manufacturing the element substrate 3010 of the second embodiment.

On the other hand, an example of a method of manufacturing the counter substrate 3520 has a step A of isotropically etching a light incident side surface of a base material 3020s made of quartz or the like to form a lens surface 3020a, a step B of forming a lens material layer by filling the lens surface 3020a using a lens material having a refractive index larger than that of the base material 3020s, a step C of forming a lens layer (second microlens ML2) by planarizing irregularities on the surface of the lens material layer, a step D of forming the second light-transmitting layer 3025 on the planarized lens layer (second microlens ML2), and a step E of forming the common electrode 3023 on the second light-transmitting layer 3025. That is, in steps A to D in the example of the manufacturing method of the counter substrate 3520, it is possible to apply the same method as the first to fourth steps in the example of the method of manufacturing the element substrate 3510.

For each of the first microlens ML1, the first light-transmitting layer 3011, the TFT layer 3014, the wiring layer including the pixel electrode 3015, the liquid crystal layer 3050, the second light-transmitting layer 3025, and the second microlens ML2, the length on the optical axis L and the refractive index are, for example, as shown in Table 2 below.

Here, the length of the lens surface 3010a of the first microlens ML1 is d11, and the length of the other portion is d12. The length of the first light-transmitting layer 3011 is d13, the length of the TFT layer 3014 is d14, the length of the wiring layer including the pixel electrode 3015 is d15, the length (thickness) of the liquid crystal layer 3050 is d16, and the length of the second light-transmitting layer 3025 including the common electrode 3023 is d17. The length of the lens surface 3020a of the second microlens ML2 is d19, and the length of the other portion is d18. The refractive index of the wiring layer including the pixel electrode 3015 is the refractive index of the interlayer insulating film between the TFT layer 3014 and the pixel electrode 3015. The refractive index of the portion corresponding to d17 is the refractive index of only the second light-transmitting layer 3025.

TABLE 2

| | Length (μm) | Refractivity |
|---|---|---|
| d11 | 3.20 | 1.64 |
| d12 | 1.00 | 1.64 |
| d13 | 5.00 | 1.46 |
| d14 | 2.77 | 1.46 |
| d15 | 1.30 | 1.46 |
| d16 | 2.10 | 1.63 |
| d17 | 8.50 | 1.50 |
| d18 | 3.00 | 1.64 |
| d19 | 3.20 | 1.64 |

According to the structure of the pixel P of the liquid crystal apparatus 3500, the light incident to the element substrate 3510 is condensed by the first microlens ML1, is transmitted through the open region of the TFT layer 3014, and is incident to the liquid crystal layer 3050 via the pixel electrode 3015. The light transmitted through the liquid crystal layer 3050 is incident to the second microlens ML2 via the common electrode 3023 and the second light-transmitting layer 3025, and is incident to the counter substrate 3520 as light including substantially parallel light along the optical axis L. The light incident to the counter substrate 3520 is transmitted through the optical compensation plate 3062 to compensate for the phase difference and emitted from the third substrate 3070.

Since the liquid crystal layer 3050 is arranged on the optical axis L at a position close to the TFT layer 3014 with respect to the liquid crystal apparatus 3200 of the third embodiment described above, when the light condensed by the first microlens ML1 is incident to the liquid crystal layer 3050, the light obliquely transmitted through the liquid crystal layer 3050 increases. In consideration of the light being obliquely transmitted through the liquid crystal layer 3050, the optical compensation plate 3062 adjusts the retardation value for compensating for the phase difference.

According to the sixth embodiment, the following effects are able to be obtained.

(1) The light incident to the element substrate 3510 is condensed by the first microlens ML1, is transmitted through the open region of the TFT layer 3014, and is incident to the liquid crystal layer 3050. The light transmitted through the liquid crystal layer 3050 is converted into light of approximately the original angle by the second microlens ML2. Accordingly, luminance unevenness due to the light condensing state in the pixel P is improved. In addition, since the phase difference caused by the light condensed by the first microlens ML1 being obliquely transmitted through the liquid crystal layer 3050 is compensated for by the optical compensation plate 3062, compared with a case where the optical compensation plate 3062 is not present, a decrease in contrast caused by the above phase difference is suppressed. That is, it is possible to provide the liquid crystal apparatus 3500 having excellent display quality while improving the utilization efficiency of incident light.

(2) Since the optical compensation plate 3062 is provided on the third substrate 3070 functioning as a dust-proof substrate, it is not necessary to separately prepare a support for the optical compensation plate 3062, and it is possible to adopt a simple configuration.

Here, in the liquid crystal apparatus 3500 of the sixth embodiment described above, as compared with the liquid crystal apparatus 3100 of the second embodiment, since the pixel electrode 3015 is arranged at a position close to the liquid crystal layer 3050, low voltage driving is possible.

### Seventh Embodiment

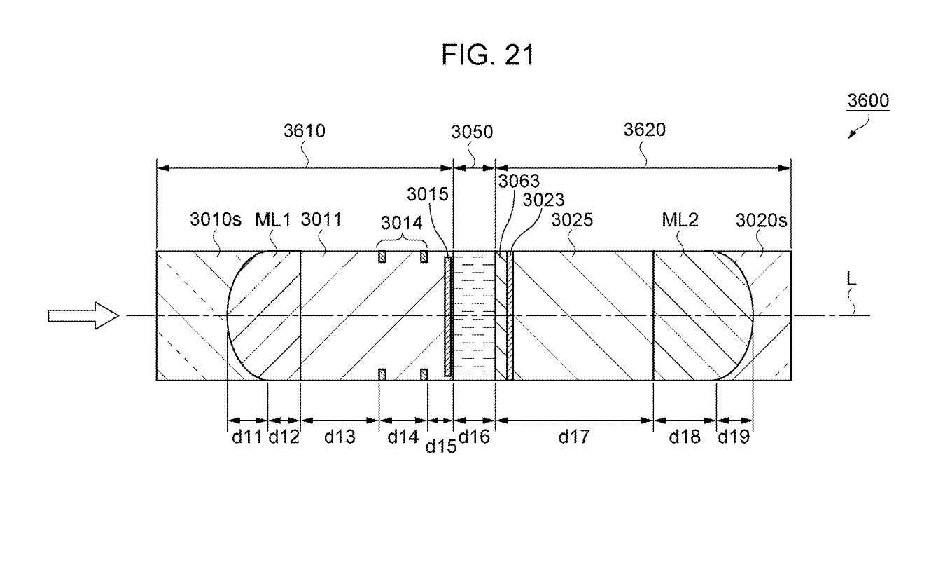

Next, description will be given of a liquid crystal apparatus of a seventh embodiment with reference to FIG. 21. FIG. 21 is a schematic cross-sectional diagram showing the structure of a pixel in the liquid crystal apparatus of the seventh embodiment. The liquid crystal apparatus of the seventh embodiment is different from the liquid crystal apparatus 3500 of the sixth embodiment in the arrangement form of the optical compensation plates. Accordingly, the same components as in the liquid crystal apparatus 3500 are denoted by the same reference numerals, and a detailed description thereof will be omitted.

As shown in FIG. 21, in the liquid crystal apparatus 3600 of the present embodiment, a liquid crystal layer 3050 is interposed between an element substrate 3610 and a counter substrate 3620.

The element substrate 3610 on the light incident side has, for each pixel P, a base material 3010s, a first microlens ML1, a first light-transmitting layer 3011, a TFT layer 3014, a pixel electrode 3015. Similarly, for each pixel P, the counter substrate 3620 has an optical compensation plate 3063, a common electrode 3023, a second light-transmitting layer 3025, a second microlens ML2, and a base material 3020s from the light incident side. That is, with respect to the liquid crystal apparatus 3500 of the sixth embodiment, the liquid crystal apparatus 3600 of the present embodiment has a configuration in which the optical compensation plate 3063 is arranged between the liquid crystal layer 3050 and the common electrode 3023. In other words, the optical compensation plate 3063 is formed to be incorporated in the counter substrate 3620.

As described in the fourth embodiment, the optical compensation plate 3063 is able to be formed as an aggregate of columnar crystals having refractive index anisotropy, for example, by obliquely depositing silicon oxide (SiO₂). Although not shown in FIG. 21, an alignment film 3024 is present between the optical compensation plate 3063 and the liquid crystal layer 3050. Since the alignment film 3024 is an inorganic alignment film, it is possible to form the optical compensation plate 3063 and the alignment film 3024 in the step of forming the alignment film 3024 on the common electrode 3023.

According to the seventh embodiment described above, in addition to the same effect as the effect (1) of the sixth embodiment, even if a dedicated manufacturing apparatus for forming the optical compensation plate 3063 is not introduced, it is possible to utilize the manufacturing apparatus which forms the alignment film 3024 and incorporating the optical compensation plate 3063 in the counter substrate 3620 makes it possible to provide a smaller liquid crystal apparatus 3600.

### Eighth Embodiment

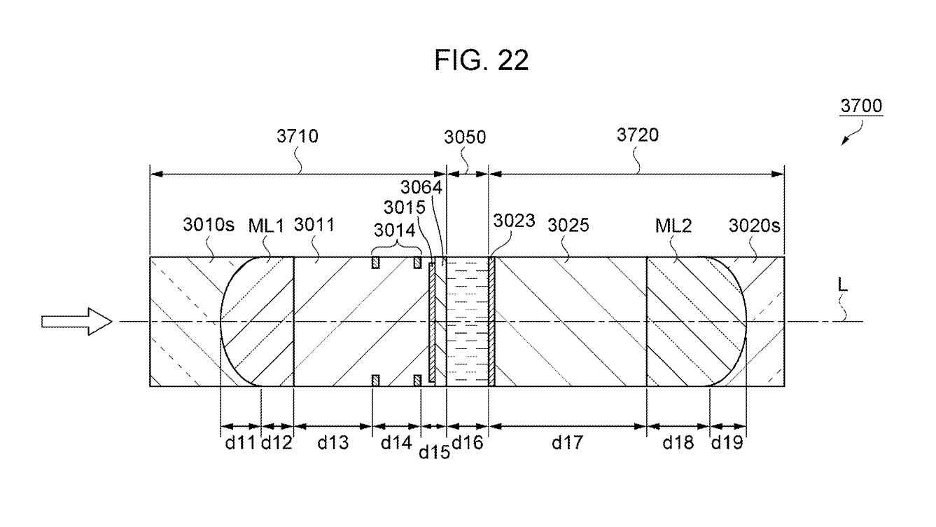

Next, description will be given of a liquid crystal apparatus of an eighth embodiment with reference to FIG. 22. FIG. 22 is a schematic cross-sectional diagram showing the structure of a pixel in the liquid crystal apparatus of the eighth embodiment. The liquid crystal apparatus of the eighth embodiment is different from the liquid crystal apparatus 3500 of the sixth embodiment described above in the arrangement form of the optical compensation plates. Accordingly, the same components as those of the liquid crystal apparatus 3500 are denoted by the same reference numerals, and a detailed description thereof will be omitted.

As shown in FIG. 22, in the liquid crystal apparatus 3700 of the present embodiment, a liquid crystal layer 3050 is interposed between an element substrate 3710 and a counter substrate 3720.

For each pixel P, the element substrate 3710 on the light incident side has a base material 3010s, a first microlens ML1, a first light-transmitting layer 3011, a TFT layer 3014, a pixel electrode 3015, and an optical compensation plate 3064 from the light incident side. Similarly, for each pixel P, the counter substrate 3720 has a common electrode 3023, a second light-transmitting layer 3025, a second microlens ML2, and a base material 3020s from the light incident side. That is, the liquid crystal apparatus 3700 of the present embodiment has a configuration in which the optical compensation plate 3064 is arranged between the liquid crystal layer 3050 and the pixel electrode 3015 with respect to the liquid crystal apparatus 3500 of the sixth embodiment display apparatus. In other words, the optical compensation plate 3064 is formed to be incorporated in the element substrate 3710.

Similar to the optical compensation plate 3063 of the seventh embodiment, it is possible to form the optical compensation plate 3064 of, for example, an aggregate of columnar crystals having refractive index anisotropy by obliquely depositing silicon oxide (SiO₂). Although not shown in FIG. 22, an alignment film 3018 is present between the optical compensation plate 3064 and the liquid crystal layer 3050. Since the alignment film 3018 is also an inorganic alignment film like the alignment film 3024 on the side of the counter substrate 3720, it is possible to form the optical compensation plate 3064 and the alignment film 3018 in the step of forming the alignment film 3018 on the pixel electrode 3015.

According to the eighth embodiment, in addition to the same effect as the effect (1) of the sixth embodiment, even if a dedicated manufacturing apparatus for forming the optical compensation plate 3064 is not introduced, it is possible to utilize the manufacturing apparatus which forms the alignment film 3018 and incorporating the optical compensation plate 3064 into the element substrate 3710 makes it possible to provide a more compact liquid crystal apparatus 3700.

Although the second to eighth embodiments have been described as embodiments of the liquid crystal apparatus of the invention, the technical idea of the invention common to the second embodiment to the eighth embodiment is that the first microlens ML1 is provided on the element substrate side so that incident light is reliably transmitted through the open region in the TFT layer 3014 of the pixel P. In addition, when the condensing ability of the first microlens ML1 is increased, the light obliquely transmitted through the liquid crystal layer 3050 with respect to the optical axis L is increased, and the phase difference is easily influenced due to the birefringence of the light of the liquid crystal layer 3050, thus an optical compensation plate for compensating the phase difference is provided.

### Ninth Embodiment

### Electronic Equipment

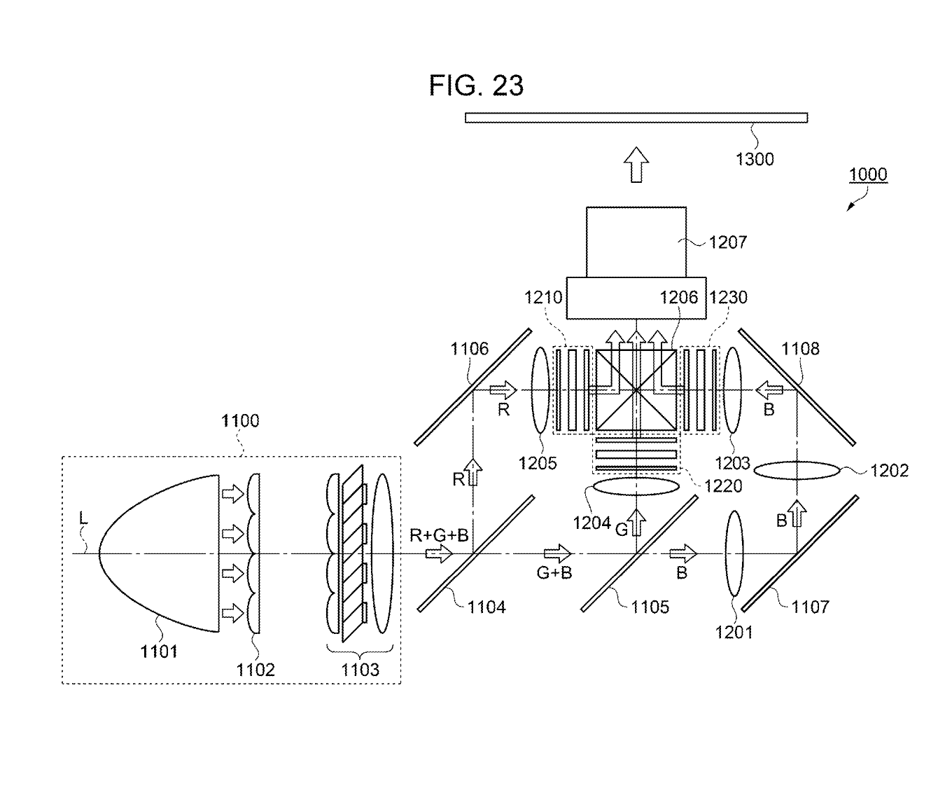

Next, description will be given of a projection-type display apparatus as an example of electronic equipment to which the liquid crystal apparatus according to the above embodiment is applied with reference to FIG. 23. FIG. 23 is a schematic diagram showing the configuration of a projection-type display apparatus.

As shown in FIG. 23, a projection-type display apparatus 1000 as electronic equipment according to the present embodiment includes a polarized light illumination apparatus 1100 arranged along the system optical axis L, and two dichroic mirrors 1104 and 1105 as light separating elements. In addition, three reflecting mirrors 1106, 1107, and 1108 and five relay lenses 1201, 1202, 1203, 1204, and 1205 are provided. Further, transmissive liquid crystal light valves 1210, 1220, 1230 are provided as three light modulating means, a cross dichroic prism 1206 is provided as a light combining element, and a projection lens 1207 is provided.

The polarized light illumination apparatus 1100 is basically formed of a lamp unit 1101 as a light source formed of a white light source such as an extra-high pressure mercury lamp or a halogen lamp, an integrator lens 1102, and a polarized light conversion element 1103.

The dichroic mirror 1104 reflects the red light (R) out of the polarized light flux emitted from the polarized light illumination apparatus 1100, and transmits the green light (G) and the blue light (B). The other dichroic mirror 1105 reflects the green light (G) transmitted through the dichroic mirror 1104 and transmits the blue light (B).

The red light (R) reflected by the dichroic mirror 1104 is reflected by the reflecting mirror 1106 and is then incident to the liquid crystal light valve 1210 via the relay lens 1205.

The green light (G) reflected by the dichroic mirror 1105 is incident to the liquid crystal light valve 1220 via the relay lens 1204.

The blue light (B) transmitted through the dichroic mirror 1105 is incident to the liquid crystal light valve 1230 via a light guiding system formed of three relay lenses 1201, 1202, and 1203 and two reflecting mirrors 1107 and 1108.

The liquid crystal light valves 1210, 1220, and 1230 are arranged opposite to the incident surface of each color light of the cross dichroic prism 1206. The color light incident to the liquid crystal light valves 1210, 1220, 1230 is modulated based on the video information (video signal) and emitted toward the cross dichroic prism 1206. In this prism, four rectangular prisms are bonded together, and on the inner surface thereof, a dielectric multilayer film which reflects red light and a dielectric multilayer film which reflects blue light are formed in a cross shape. Three color lights are synthesized by these dielectric multilayer films, and light representing a color image is synthesized. The synthesized light is projected on the screen 1300 by the projection lens 1207 which is a projection optical system, and the image is enlarged and displayed.

The liquid crystal light valve 1210 is a valve to which the liquid crystal apparatus 3100 (see FIG. 9) of the second embodiment described above is applied. A pair of light-polarizing elements arranged in a crossed Nicols state on the incident side and the emission side of the color light of the liquid crystal apparatus 3100 are arranged with a gap therebetween. Here, an optical compensation plate 3061 is provided between the light-polarizing element on the emission side and the counter substrate 3020. The same applies to the other liquid crystal light valves 1220 and 1230.

According to such a projection-type display apparatus 1000, since the liquid crystal apparatus 3100 of the second embodiment described above is used as the liquid crystal light valves 1210, 1220, and 1230, color light is effectively utilized as incident light and the phase difference due to the birefringence of the light of the liquid crystal layer 3050 is compensated for by the optical compensation plate 3061. Accordingly, it is possible to provide a projection-type display apparatus 1000 capable of realizing a bright display, realizing a high contrast, and realizing a projection state with a good appearance.

Here, the liquid crystal light valves 1210, 1220, and 1230 are able to be applied not only to the liquid crystal apparatus 3100 of the second embodiment described above, but also the liquid crystal apparatus 3200 of the third embodiment described above, the liquid crystal apparatus 3300 of the fourth embodiment described above, the liquid crystal apparatus 3400 of the fifth embodiment described above, the liquid crystal apparatus 3500 of the sixth embodiment described above, the liquid crystal apparatus 3600 of the seventh embodiment described above, and the liquid crystal apparatus 3700 of the eighth embodiment described above.

In addition, the electronic equipment to which the liquid crystal apparatuses 3100 to 700 according to the embodiments described above are applicable is not limited to the projection-type display apparatus 1000 of the ninth embodiment and is able to be suitably applied as a display portion of a head mounted display (HMD) or a head up display (HUD).

The invention is not limited to the embodiment described above and is able to appropriately changed within the scope of the invention or in a range which does not depart from the technical idea read from the claims and the entire specification, and liquid crystal apparatuses changed as above and electronic equipment to which the liquid crystal apparatus is applied are also included in the technical scope of the invention. Various Modification Examples other than the embodiments described above may be considered. Below, description will be given of examples of Modification Examples.

### Modification Example 1

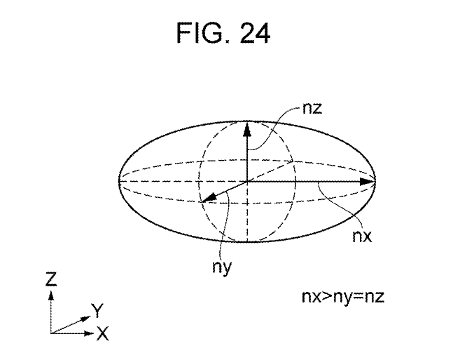

The optical compensation plate is not limited to a C plate, an O plate, or a combination thereof. FIG. 24 is a diagram showing an example of an A plate (refractive index ellipsoid) as an optical compensation plate. As shown in FIG. 24, in the A plate, the refractive indices nx, ny, and nz of the optical axes (x, y, z) in the refractive index ellipsoid satisfy the relationship of nx>ny=nz. The slow axis in the A plate is the optical axis x with the highest refractive index. Specific examples of the A plate include a retardation film in which a polymer film such as polyvinyl alcohol (PVA) or polychlorinated biphenyl (PC) is stretched in one axis direction to control the alignment state of the polymer.

For example, in a case where the alignment state of liquid crystal molecules in the liquid crystal layer 3050 is a Twisted Nematic (TN) type horizontal alignment state, it is conceivable to use an A plate. That is, the alignment state of the liquid crystal molecules in the liquid crystal layer 3050 is not limited to substantially vertical alignment (VA) and a TN type, an In Plane Switching (IPS) type, an Optically Compensated Bend (OCB) type, or the like may be considered, and the optical compensation plate may be formed by selecting and using at least one type of the A plate, the C plate, and the O plate in consideration of the state of birefringence of the light of the liquid crystal layer 3050.

### Modification Example 2

In the liquid crystal apparatus of the embodiment described above, the number of optical compensation plates is not limited to one. For example, a configuration having a plurality of optical compensation plates by a combination of the arrangements of the optical compensation plates of the second embodiment or the third embodiment and the fourth embodiment or the fifth embodiment may be used. Alternatively, a configuration having a pair of optical compensation plates 3063 and 3064 with a liquid crystal layer 3050 in between by combining the fourth embodiment and the fifth embodiment may be used. The value of the retardation in each optical compensation plate may be a value obtained by dividing the retardation value, which is able to compensate for the retardation due to the birefringence of the light of the liquid crystal layer 3050, by the number of optical compensation plates. It is also possible to combine the sixth to eighth embodiments in the same manner.

### Modification Example 3

In the liquid crystal apparatus according to the embodiments described above, the first microlens ML1 is not limited to the lens surface 3010a having a substantially hemispherical shape. For example, the apex portion including the planar center of the first microlens ML1 may be formed with a flat surface. Since the light incident to the apex portion of the first microlens ML1 includes a large amount of light along the optical axis L, forming the apex portion of the first microlens ML1 to be a flat surface makes it possible to increase the light transmitted along the optical axis L out of the light transmitted through the liquid crystal layer 3050. In other words, it is possible to suppress a decrease in contrast caused by the phase difference of the light obliquely transmitted through the liquid crystal layer 3050.

This application claims priority to Japan Patent Application No. 2016-10538 filed Jan. 22, 2016 and Japan Patent Application No. 2016-206617 filed Oct. 21, 2016, the entire disclosures of which are hereby incorporated by reference in their entireties.

What is claimed is:

1. An electro-optical apparatus comprising:
an element substrate which emits light transmitted through a microlens;
an electro-optical layer which transmits light incident from the element substrate;
a counter substrate which transmits light incident from the electro-optical layer; and
an optical compensation plate provided on a light emission side of the element substrate.

2. The electro-optical apparatus according to claim 1,
wherein the optical compensation plate is provided on a light emission side of the counter substrate.

3. The electro-optical apparatus according to claim 1,
wherein the optical compensation plate is provided on a light emission side of the electro-optical layer and on a light incident side of the counter substrate.

4. The electro-optical apparatus according to claim 1, further comprising:
a pixel electrode provided on the electro-optical layer side of the element substrate,
wherein the optical compensation plate is provided on an element substrate side of the pixel electrode.

5. The electro-optical apparatus according to claim 1,
wherein the optical compensation plate is formed of an inorganic material.

6. The electro-optical apparatus according to claim 1,
wherein the optical compensation plate includes a uniaxial phase difference plate.

7. The electro-optical apparatus according to claim 6,
wherein the optical compensation plate includes a C plate.

8. The electro-optical apparatus according to claim 1,
wherein the optical compensation plate includes a biaxial phase difference plate.

9. Electronic equipment comprising:
the electro-optical apparatus according to claim 1.

10. A liquid crystal apparatus comprising:
a liquid crystal layer which is interposed between a first substrate and a second substrate,
wherein light is incident from a first substrate side toward the liquid crystal layer,
the first substrate has, for each pixel, a pixel electrode, a transistor related to switching control of the pixel electrode, a first microlens provided further to a light incident side than a wiring layer in which the transistor is provided, and a second microlens provided between the wiring layer and the liquid crystal layer, and
an optical compensation plate which compensates for a phase difference of the liquid crystal layer is provided.

11. A liquid crystal apparatus comprising:
a liquid crystal layer which is interposed between a first substrate and a second substrate,
wherein light is incident from a first substrate side toward the liquid crystal layer,
the first substrate has, for each pixel, a pixel electrode, a transistor related to switching control of the pixel electrode, and a first microlens provided further to a light incident side than a wiring layer in which the transistor is provided,
the second substrate has, for each pixel, a second microlens provided corresponding to the first microlens, and
an optical compensation plate which compensates for a phase difference of the liquid crystal layer is provided.

12. The liquid crystal apparatus according to claim 10,
wherein the optical compensation plate is provided on a light emission side of the second substrate.

13. The liquid crystal apparatus according to claim 10, further comprising:
a third substrate provided with the optical compensation plate,
wherein the third substrate is provided on a light emission side of the second substrate.

14. The liquid crystal apparatus according to claim 10,
wherein the optical compensation plate is provided on a liquid crystal layer side of the second substrate.

15. The liquid crystal apparatus according to claim 10,
wherein the optical compensation plate is provided on a liquid crystal layer side of the first substrate.

16. The liquid crystal apparatus according to claim 10,
wherein the optical compensation plate is at least one type selected from an A plate, a C plate, and an O plate.

17. The liquid crystal apparatus according to claim 10,
wherein a slow axis of the optical compensation plate is inclined in a direction opposite to a pretilt direction of liquid crystal molecules in the liquid crystal layer.

18. Electronic equipment comprising:
the liquid crystal apparatus according to claim 10.

19. Electronic equipment comprising:
the liquid crystal apparatus according to claim 11.
